(19) United States
(12) Patent Application Publication
(10) Pub. No.: US 2025/0283594 A1
(43) Pub. Date: Sep. 11, 2025

(54) VAPOR GENERATION SYSTEM AND APPARATUS

(71) Applicant: General Electric Company, Schenectady, NY (US)

(72) Inventor: Jeffrey Douglas Rambo, Mason, OH (US)

(21) Appl. No.: 18/596,825

(22) Filed: Mar. 6, 2024

(51) Int. Cl. F22B 37/26; F22B 37/10

(52) U.S. Cl. CPC F22B 37/266; F22B 37/104

(57) ABSTRACT

A vapor generation apparatus includes a fluid channel extending between a first end and a second end of the vapor generation apparatus, a plurality of first fluid passageways extending between the first end and the second end, and a plurality of second fluid passageways extending between the first end and the second end. The plurality of first fluid passageways are between the fluid channel and the plurality of second fluid passageways. The vapor generation apparatus also includes a fluid chamber adjacent the second end and configured to receive a first fluid and a separator adjacent the first end and in fluid communication with the fluid channel, the plurality of first fluid passageways, and the plurality of second fluid passageways. The fluid chamber is in fluid communication with the fluid channel and the plurality of first fluid passageways.

### FIELD

The present disclosure relates to turbine engines including steam systems.

### BACKGROUND

Turbine engines generally include a fan and a core section arranged in flow communication with one another. A combustor is arranged in the core section to generate combustion gases for driving a turbine in the core section of the turbine engine.

Turbine engines may also include a steam system to extract steam from the combustion gases. The extracted steam may drive a steam turbine connected to the turbine of the turbine engine. However, steam systems that improve the separation of the steam from liquid flowing though the steam system are desirable.

### BRIEF DESCRIPTION OF THE DRAWINGS

A full and enabling disclosure of the present disclosure, including the best mode thereof, directed to one of ordinary skill in the art, is set forth in the specification, which makes reference to the appended figures, in which:

FIG. 1 is a schematic cross-sectional view of a turbine engine according to an exemplary embodiment of the present disclosure.

FIG. 2 is a schematic diagram of the turbine engine of FIG. 1 and a steam system with a thermal transport system according to an exemplary embodiment of the present disclosure.

FIG. 3 is a schematic diagram of a vapor generation system of the turbine engine of FIGS. 1-2 according to an exemplary embodiment of the present disclosure.

FIG. 4A is a perspective, detailed view of a separator of the vapor generation system of FIG. 3 according to an exemplary embodiment of the present disclosure.

FIG. 4B is a cross-sectional view of the separator of the vapor generation system of FIG. 4A according to an exemplary embodiment of the present disclosure.

FIG. 4C is a detailed, cross-sectional view of the separator of the vapor generation system of FIG. 4B according to an exemplary embodiment of the present disclosure.

FIG. 5A is a perspective view of one of a plurality of separation passageways of the separator of FIGS. 4A-4C according to an exemplary embodiment of the present disclosure.

FIG. 5B is a rear, perspective view of the plurality of separation passageways of FIG. 5A according to an exemplary embodiment of the present disclosure.

FIG. 6A is a perspective view of the vapor generation system of FIG. 3 according to an exemplary embodiment of the present disclosure.

FIG. 6B is a cross-sectional view of the vapor generation system of FIG. 6A according to an exemplary embodiment of the present disclosure.

FIG. 7A is a perspective view of a vapor generation system according to an exemplary embodiment of the present disclosure.

FIG. 7B is a cross-sectional view of the vapor generation system of FIG. 6A according to an exemplary embodiment of the present disclosure.

FIG. 8A is a perspective view of another vapor generation system of the turbine engine of FIGS. 1-2 according to an exemplary embodiment of the present disclosure.

FIG. 8B is a cross-sectional view of the vapor generation system of FIG. 8A according to an exemplary embodiment of the present disclosure.

FIG. 8C is a cross-sectional view of the vapor generation system of FIG. 8A according to an exemplary embodiment of the present disclosure.

### DETAILED DESCRIPTION

Reference will now be made in detail to present embodiments of the disclosure, one or more examples of which are illustrated in the accompanying drawings. The detailed description uses numerical and letter designations to refer to features in the drawings. Like or similar designations in the drawings and description have been used to refer to like or similar parts of the disclosure.

The word “exemplary” is used herein to mean “serving as an example, instance, or illustration.” Any implementation described herein as “exemplary” is not necessarily to be construed as preferred or advantageous over other implementations. Additionally, unless specifically identified otherwise, all embodiments described herein should be considered exemplary.

The singular forms “a,” “an,” and “the” include plural references unless the context clearly dictates otherwise.

The term “at least one of” in the context of, e.g., “at least one of A, B, and C” refers to only A, only B, only C, or any combination of A, B, and C.

The term “at least one of” in the context of, e.g., “at least one of A, B, and C” refers to only A, only B, only C, or any combination of A, B, and C.

The term “turbine engine” refers to an engine having a turbomachine as all or a portion of its power source. Example turbine engines include turbofan engines, turboprop engines, turbojet engines, turboshaft engines, etc., as well as hybrid-electric versions of one or more of these engines.

The term “combustion section” refers to any heat addition system for a turbomachine. For example, the term combustion section may refer to a section including one or more of a deflagrative combustion assembly, a rotating detonation combustion assembly, a pulse detonation combustion assembly, or other appropriate heat addition assembly. In certain example embodiments, the combustion section may include an annular combustor, a can combustor, a cannular combustor, a trapped vortex combustor (TVC), or other appropriate combustion system, or combinations thereof.

The terms “upstream” and “downstream” refer to the relative direction with respect to fluid flow in a fluid pathway. For example, “upstream” refers to the direction from which the fluid flows, and “downstream” refers to the direction to which the fluid flows.

As used herein, the terms “axial” and “axially” refer to directions and orientations that extend substantially parallel to a centerline of the gas turbine engine. Moreover, the terms “radial” and “radially” refer to directions and orientations that extend substantially perpendicular to the centerline of the gas turbine engine. In addition, as used herein, the terms “circumferential” and “circumferentially” refer to directions and orientations that extend arcuately about the centerline of the gas turbine engine.

As used herein, a “bypass ratio” of a turbine engine is a ratio of bypass air through a bypass of the turbine engine to core air through a core inlet of a turbomachine of the turbine engine. For example, the bypass ratio is a ratio of bypass air 62 entering the bypass airflow passage 56 to core air 64 entering the turbomachine 16.

The terms “coupled,” “fixed,” “attached to,” and the like refer to both direct coupling, fixing, or attaching, as well as indirect coupling, fixing, or attaching through one or more intermediate components or features, unless otherwise specified herein.

As used herein, the terms “first,” “second,” and “third” may be used interchangeably to distinguish one component from another and are not intended to signify location or importance of the individual components.

For purposes of the description hereinafter, the terms “upper,” “lower,” “right,” “left,” “vertical,” “horizontal,” “top,” “bottom,” “lateral,” “longitudinal,” and derivatives thereof shall relate to the embodiments as they are oriented in the drawing figures. However, it is to be understood that the embodiments may assume various alternative variations, except where expressly specified to the contrary. It is also to be understood that the specific devices illustrated in the attached drawings, and described in the following specification, are simply exemplary embodiments of the disclosure. Hence, specific dimensions and other physical characteristics related to the embodiments disclosed herein are not to be considered as limiting.

As used herein, the term “complementary” with reference to a radius of curvature of two radii of curvature, refers to the two radii of curvature being equal, or a larger of two the radii of curvature being no more than 10% greater than a smaller of the two radii of curvature.

The term “adjacent” as used herein with reference to two walls and/or surfaces refers to the two walls and/or surfaces contacting one another, or the two walls and/or surfaces being separated only by one or more nonstructural layers and the two walls and/or surfaces and the one or more nonstructural layers being in a serial contact relationship (e.g., a first wall/surface contacting the one or more nonstructural layers, and the one or more nonstructural layers contacting a second wall/surface).

The present disclosure is generally related to turbine engines including steam systems. Within the steam system, steam is separated from liquid. In some example embodiments, the steam system includes a heat exchanger for separating the steam from the liquid. For example, the heat exchanger may include a separator, such as an inertial separator, for separating the liquid from the steam.

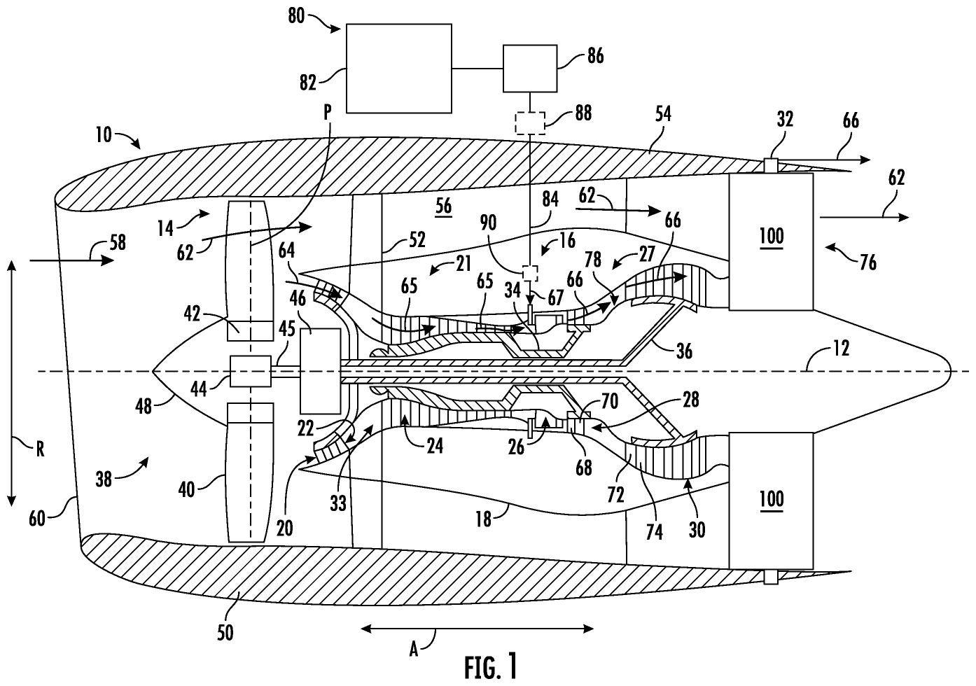

Referring now to the drawings, FIG. 1 is a schematic cross-sectional view of a turbine engine 10 according to an exemplary embodiment of the present disclosure.

In at least one example embodiment, the turbine engine 10 includes a steam system 100. As shown in FIG. 1, the turbine engine 10 has an axial direction A (extending parallel to a longitudinal centerline axis 12) and a radial direction R that is normal to the axial direction A. In general, the turbine engine 10 includes a fan section 14 and a turbomachine 16 disposed downstream from the fan section 14.

The turbomachine 16 includes an outer casing 18 that is substantially tubular and defines an annular core inlet 20. As schematically shown in FIG. 1, the outer casing 18 encases, in serial flow relationship, a compressor section 21 including a booster or a low-pressure compressor (“LPC”) 22 followed downstream by a high-pressure compressor (“HPC”) 24, a combustor 26, a turbine section 27, including a high-pressure turbine (“HPT”) 28, followed downstream by a low-pressure turbine (“LPT”) 30, and one or more core exhaust nozzles 32. A high-pressure (“HP”) shaft 34 or a spool drivingly connects the HPT 28 to the HPC 24 to rotate the HPT 28 and the HPC 24 in unison. The HPT 28 is drivingly coupled to the HP shaft 34 to rotate the HP shaft 34 when the HPT 28 rotates. A low-pressure (“LP”) shaft 36 drivingly connects the LPT 30 to the LPC 22 to rotate the LPT 30 and the LPC 22 in unison. The LPT 30 is drivingly coupled to the LP shaft 36 to rotate the LP shaft 36 when the LPT 30 rotates. The compressor section 21, the combustor 26, the turbine section 27, and the one or more core exhaust nozzles 32 together define a working gas flow path 33.

For the embodiment depicted in FIG. 1, the fan section 14 includes a fan 38 (e.g., a variable pitch fan) having a plurality of fan blades 40 coupled to a disk 42 in a spaced apart manner. As depicted in FIG. 1, the fan blades 40 extend outwardly from the disk 42 generally along the radial direction R. Each fan blade 40 is rotatable relative to the disk 42 about a pitch axis P by virtue of the fan blades 40 being operatively coupled to an actuator 44 configured to collectively vary the pitch of the fan blades 40 in unison. The fan blades 40, the disk 42, and the actuator 44 are together rotatable about the longitudinal centerline axis 12 via a fan shaft 45 that is powered by the LP shaft 36 across a power gearbox, also referred to as a gearbox assembly 46. The gearbox assembly 46 is shown schematically in FIG. 1. The gearbox assembly 46 includes a plurality of gears for adjusting the rotational speed of the fan shaft 45 and, thus, the fan 38 relative to the LP shaft 36.

Referring still to the exemplary embodiment of FIG. 1, the disk 42 is covered by a rotatable fan hub 48 aerodynamically contoured to promote an airflow through the plurality of fan blades 40. In addition, the fan section 14 includes an annular fan casing or a nacelle 50 that circumferentially surrounds the fan 38 and/or at least a portion of the turbomachine 16. The nacelle 50 is supported relative to the turbomachine 16 by a plurality of circumferentially spaced outlet guide vanes 52. Moreover, a downstream section 54 of the nacelle 50 extends over an outer portion of the turbomachine 16 to define a bypass airflow passage 56 therebetween. The one or more core exhaust nozzles 32 may extend through the nacelle 50 and be formed therein. In this exemplary embodiment, the one or more core exhaust nozzles 32 include one or more discrete nozzles that are spaced circumferentially about the nacelle 50. Other arrangements of the core exhaust nozzles 32 may be used including, for example, a single core exhaust nozzle that is annular, or partially annular, about the nacelle 50.

During operation of the turbine engine 10, a volume of air 58 enters the turbine engine 10 through an inlet 60 of the nacelle 50 and/or the fan section 14. As the volume of air 58 passes across the fan blades 40, a first portion of air (bypass air 62) is directed or routed into the bypass airflow passage 56, and a second portion of air (core air 64) is directed or is routed into the upstream section of the working gas flow path 33, or, more specifically, into the annular core inlet 20. The ratio between the first portion of air (bypass air 62) and the second portion of air (core air 64) is known as a bypass ratio. In some embodiments, the bypass ratio is greater than 18:1, enabled by a steam system 100, detailed further below. The pressure of the core air 64 is increased by the LPC 22, generating compressed air 65, and the compressed air 65 is routed through the HPC 24 and further compressed before being directed into the combustor 26, where the compressed air 65 is mixed with fuel 67 and burned to generate combustion gases 66 (combustion products). One or more stages may be used in each of the LPC 22 and the HPC 24, with each subsequent stage further compressing the compressed air 65. The HPC 24 has a compression ratio greater than 20:1, preferably, in a range of 20:1 to 40:1. The compression ratio is a ratio of a pressure of a last stage of the HPC 24 to a pressure of a first stage of the HPC 24. The compression ratio greater than 20:1 is enabled by the steam system 100, as detailed further below.

The combustion gases 66 are routed into the HPT 28 and expanded through the HPT 28 where a portion of thermal energy and/or kinetic energy from the combustion gases 66 is extracted via sequential stages of HPT stator vanes 68 that are coupled to the outer casing 18 and HPT rotor blades 70 that are coupled to the HP shaft 34, thus, causing the HP shaft 34 to rotate, thereby supporting operation of the HPC 24. The combustion gases 66 are routed into the LPT 30 and expanded through the LPT 30. Here, a second portion of thermal energy and/or the kinetic energy is extracted from the combustion gases 66 via sequential stages of LPT stator 72 that are coupled to the outer casing 18 and LPT rotor blades 74 that are coupled to the LP shaft 36, thus, causing the LP shaft 36 to rotate, thereby supporting operation of the LPC 22 and rotation of the fan 38 via the gearbox assembly 46. One or more stages may be used in each of the HPT 28 and the LPT 30. The HPC 24 having a compression ratio in a range of 20:1 to 40:1 enables the HPT 28 to have a pressure expansion ratio in a range of 1.5:1 to 4:1 and the LPT 30 having a pressure expansion ratio in a range of 4.5:1 to 28:1.

The combustion gases 66 are subsequently routed through the one or more core exhaust nozzles 32 of the turbomachine 16 to provide propulsive thrust. Simultaneously with the flow of the core air 64 through the working gas flow path 33, the bypass air 62 is routed through the bypass airflow passage 56 before being exhausted from a fan bypass nozzle 76 of the turbine engine 10, also providing propulsive thrust. The HPT 28, the LPT 30, and the one or more core exhaust nozzles 32 at least partially define a hot gas path 78 for routing the combustion gases 66 through the turbomachine 16.

As noted above, the compressed air 65 (the core air 64) is mixed with the fuel 67 in the combustor 26 to generate a fuel and air mixture, and combusted, generating combustion gases 66 (combustion products). The fuel 67 can include any type of fuel used for turbine engines, such as, for example, sustainable aviation fuels (SAF) including biofuels, JetA, or other hydrocarbon fuels. The fuel 67 also may be a hydrogen-based fuel (H₂), and, while hydrogen-based fuel may include blends with hydrocarbon fuels, the fuel 67 used herein is preferably unblended, and referred to herein as hydrogen fuel. In some embodiments, the hydrogen fuel may comprise substantially pure hydrogen molecules (i.e., diatomic hydrogen). The fuel 67 may also be a cryogenic fuel. For example, when the hydrogen fuel is used, the hydrogen fuel may be stored in a liquid phase at cryogenic temperatures.

The turbine engine 10 includes a fuel system 80 for providing the fuel 67 to the combustor 26. The fuel system 80 includes a fuel tank 82 for storing the fuel 67 therein, and a fuel delivery assembly 84. The fuel tank 82 can be located on an aircraft (not shown) to which the turbine engine 10 is attached. While a single fuel tank 82 is shown in FIG. 1, the fuel system 80 can include any number of fuel tanks 82, as desired. The fuel delivery assembly 84 delivers the fuel 67 from the fuel tank 82 to the combustor 26. The fuel delivery assembly 84 includes one or more lines, conduits, pipes, tubes, etc., configured to carry the fuel 67 from the fuel tank 82 to the combustor 26. The fuel delivery assembly 84 also includes a pump 86 to induce the flow of the fuel 67 through the fuel delivery assembly 84 to the combustor 26. Steam injected directly into or upstream of the combustor 26 adds mass flow to the core air 64 such that less core air 64 is needed to produce the same amount of work through the turbine section 27. In this way, the pump 86 pumps the fuel 67 from the fuel tank 82, through the fuel delivery assembly 84, and into the combustor 26. The fuel system 80 and, more specifically, the fuel tank 82 and the fuel delivery assembly 84, either collectively or individually, may be a fuel source for the combustor 26.

In some embodiments, for example, when the fuel 67 is a hydrogen fuel, the fuel system 80 includes one or more vaporizers 88 (illustrated by dashed lines) and a metering valve 90 (illustrated by dashed lines) in fluid communication with the fuel delivery assembly 84. In this example, the hydrogen fuel is stored in the fuel tank 82 as liquid hydrogen fuel. The one or more vaporizers 88 heat the liquid hydrogen fuel flowing through the fuel delivery assembly 84. The one or more vaporizers 88 are positioned in the flow path of the fuel 67 between the fuel tank 82 and the combustor 26 and are located downstream of the pump 86. The one or more vaporizers 88 are in thermal communication with at least one heat source, such as, for example, waste heat from the turbine engine 10 and/or from one or more systems of the aircraft (not shown). The one or more vaporizers 88 heat the liquid hydrogen fuel and convert the liquid hydrogen fuel into a gaseous hydrogen fuel within the one or more vaporizers 88. The fuel delivery assembly 84 directs the gaseous hydrogen fuel into the combustor 26.

The metering valve 90 is positioned downstream of the one or move vaporizers 88 and the pump 86. The metering valve 90 receives hydrogen fuel in a substantially completely gaseous phase, or in a substantially completely supercritical phase. The metering valve 90 provides the flow of fuel to the combustor 26 in a desired manner. More specifically, the metering valve 90 provides a desired volume of hydrogen fuel at, for example, a desired flow rate, to a fuel manifold that includes one or more fuel injectors that inject the hydrogen fuel into the combustor 26. The fuel system 80 can include any components for supplying the fuel 67 from the fuel tank 82 to the combustor 26, as desired.

The turbine engine 10 includes the steam system 100 in fluid communication with the one or more core exhaust nozzles 32 and the fan bypass nozzle 76. The steam system 100 extracts steam from the combustion gases 66 as the combustion gases 66 flow through the steam system 100, as detailed further below.

The turbine engine 10 depicted in FIG. 1 is by way of example only. In other exemplary embodiments, the turbine engine 10 may have any other suitable configuration. For example, in other exemplary embodiments, the fan 38 may be configured in any other suitable manner (e.g., as a fixed pitch fan) and further may be supported using any other suitable fan frame configuration. Moreover, in other exemplary embodiments, any other suitable number or configuration of compressors, turbines, shafts, or a combination thereof may be provided. In still other exemplary embodiments, aspects of the present disclosure may be incorporated into any other suitable turbine engine, such as, for example, turbofan engines, propfan engines, and/or turboprop engines.

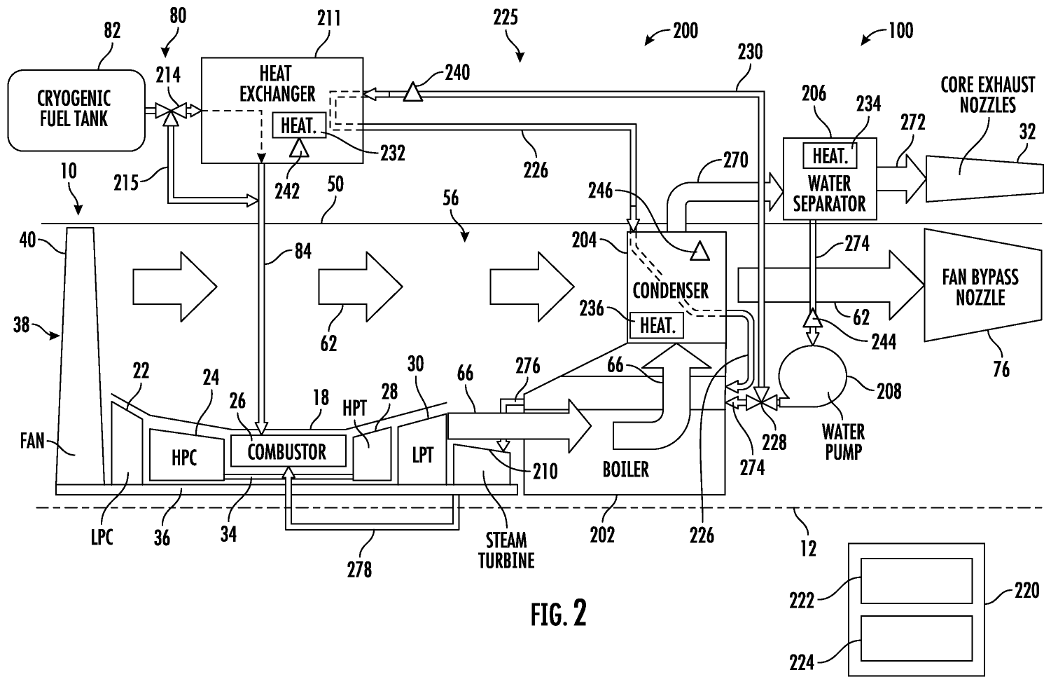

FIG. 2 is a schematic diagram of the turbine engine 10 of FIG. 1 and the steam system 100 with a thermal transport system 200 according to an exemplary embodiment of the present disclosure. The turbine engine 10 is shown schematically in FIG. 2 and some components are not shown in FIG. 2.

In at least one example embodiment, the steam system 100 includes a boiler 202, a condenser 204, a water separator 206, a water pump 208, and a steam turbine 210. The boiler 202 is a heat exchanger that vaporizes liquid water from a water source to generate steam or water vapor, as detailed further below. The boiler 202 is thus a steam source. In particular, the boiler 202 is an exhaust gas-water heat exchanger. The boiler 202 is in fluid communication with the hot gas path 78 (FIG. 1) and is positioned downstream of the LPT 30. The boiler 202 is also in fluid communication with the water pump 208, as detailed further below. The boiler 202 can include any type of boiler or heat exchanger for extracting heat from the combustion gases 66 and vaporizing liquid water into steam or water vapor as the liquid water and the combustion gases 66 flow through the boiler 202.

The condenser 204 is a heat exchanger that further cools the combustion gases 66 as the combustion gases 66 flow through the condenser 204, as detailed further below. In particular, the condenser 204 is an air-exhaust gas heat exchanger. The condenser 204 is in fluid communication with the boiler 202 and, in this embodiment, is positioned within the bypass airflow passage 56. The condenser 204, however, may be positioned elsewhere and thermally connected to other cooling sources, such as being thermally connected to the fuel 67 to transfer heat to the fuel 67, particularly, when the fuel 67 is a cryogenic fuel such as hydrogen fuel. The condenser 204 can include any type of condenser for condensing water from the exhaust (e.g., the combustion gases 66).

The water separator 206 is in fluid communication with the condenser 204 for receiving cooled exhaust (combustion gases 66) having condensed water entrained therein. The water separator 206 is also in fluid communication with the one or more core exhaust nozzles 32 and with the water pump 208. The water separator 206 includes any type of water separator for separating water from the exhaust. For example, the water separator 206 can include a cyclonic separator that uses vortex separation to separate the water from the air. In such embodiments, the water separator 206 generates a cyclonic flow within the water separator 206 to separate the water from the cooled exhaust. In FIG. 2, the water separator 206 is schematically depicted as being in the nacelle 50, but the water separator 206 could be located at other locations within the turbine engine 10, such as, for example, radially inward of the nacelle 50, closer to the turbomachine 16. The water separator 206 may be driven to rotate by one of the engine shafts, such as the HP shaft 34 or the LP shaft 36. As noted above, the boiler 202 receives liquid water from a water source to generate steam or water vapor. In the embodiment depicted in FIG. 2, the condenser 204 and the water separator 206, individually or collectively, are the water source for the boiler 202.

The water pump 208 is in fluid communication with the water separator 206 and with the boiler 202. The water pump 208 is in fluid communication with the condenser 204 via the water separator 206. The water pump 208 may be any suitable pump, such as a centrifugal pump or a positive displacement pump. The water pump 208 directs the separated liquid water through the boiler 202 where it is converted back to steam. This steam is sent through the steam turbine 210, then injected into working gas flow path 33, such as into the combustor 26.

In operation, the combustion gases 66, also referred to as exhaust, flow from the LPT 30 into the boiler 202. The combustion gases 66 transfer heat into the water 274 (e.g., in liquid form) within the boiler 202, as detailed further below. The combustion gases 66 flow into the condenser 204. The condenser 204 condenses the water 274 (e.g., in liquid form) from the combustion gases 66. The bypass air 62 flows through the bypass airflow passage 56 and over or through the condenser 204 and extracts heat from the combustion gases 66, cooling the combustion gases 66 and condensing the water 274 from the combustion gases 66, to generate an exhaust-water mixture 270. The bypass air 62 is exhausted out of the turbine engine 10 through the fan bypass nozzle 76 to generate thrust, as detailed above. The condenser 204 thus may be positioned in bypass airflow passage 56.

The exhaust-water mixture 270 flows into the water separator 206. The water separator 206 separates the water 274 from the exhaust of the exhaust-water mixture 270 to generate separate exhaust 272 and the water 274. The exhaust 272 is exhausted out of the turbine engine 10 through the one or more core exhaust nozzles 32 to generate thrust, as detailed above. The boiler 202, the condenser 204, and the water separator 206 thus also define a portion of the hot gas path 78 (see FIG. 1) for routing the combustion gases 66, the exhaust-water mixture 270, and the exhaust 272 through the steam system 100 of the turbine engine 10.

The water pump 208 pumps the water 274 (e.g., in liquid form) through one or more water lines (as indicated by the arrow for the water 274 in FIG. 2) and the water 274 flows through the boiler 202. As the water 274 flows through the boiler 202, the combustion gases 66 flowing through the boiler 202 transfer heat into the water 274 to vaporize the water 274 and to generate the steam 276 (e.g., vapor). The steam turbine 210 includes one or more stages of steam turbine blades (not shown) and steam turbine stators (not shown). The steam 276 flows from the boiler 202 into the steam turbine 210, through one or more steam lines (as indicated by the arrow for the steam 276 in FIG. 2), causing the steam turbine blades of the steam turbine 210 to rotate, thereby generating additional work in an output shaft (e.g., one of the core shafts) connected to the turbine blades of the steam turbine 210.

As noted above, the turbomachine 16 includes shafts, also referred to as core shafts, coupling various rotating components of the turbomachine 16 and other thrust producing components such as the fan 38. In the turbomachine 16 shown in FIG. 1, these core shafts include the HP shaft 34 and the LP shaft 36. The steam turbine 210 is coupled to one of the core shafts of the turbomachine 16, such as the HP shaft 34 or the LP shaft 36. In the illustrated embodiment, the steam turbine 210 is coupled to the LP shaft 36. As the steam 276 flows from the boiler 202 through the steam turbine 210, the kinetic energy of this gas is converted by the steam turbine 210 into mechanical work in the LP shaft 36. The reduced temperature steam (as steam 278) exiting the steam turbine 210 is injected into the working gas flow path 33, such as into the combustor 26, upstream of the combustor 26, or downstream of the combustor 26. The steam 278 flows through one or more steam lines from the steam turbine 210 to the working gas flow path 33. The steam 278 injected into the working gas flow path 33 adds mass flow to the core air 64 such that less core air 64 is needed to produce the same amount of work through the turbine section 27. In this way, the steam system 100 extracts additional work from the heat in exhaust gas that would otherwise be wasted. The steam 278 injected into the working gas flow path 33 is in a range of about 20% to about 50% of the mass flow through the working gas flow path 33.

The steam turbine 210 may have a pressure expansion ratio in a range of 2:1 to 6:1. The pressure expansion ratio is a ratio of the pressure at an inlet of the steam turbine 210 to the pressure at an exit of the steam turbine 210. The steam turbine 210 may contribute approximately 25% of the power to the LP shaft 36 (or to the HP shaft 34) when the steam system 100 recovers approximately 70% of the water 274 and converts the water 274 into the steam 276. The steam turbine 210 has a pressure expansion ratio in a range of about 2:1 to about 6:1, the LPT 30 has a pressure expansion ratio in a range of about 4.5:1 to about 28:1, and the steam 278 contributes to about 20% to about 50% of the mass flow through the working gas flow path 33. The steam turbine 210 expands the steam 276, thereby reducing the energy of the steam 278 exiting the steam turbine 210 and reducing the temperature of the steam 278 to approximately a temperature of the compressed air 65 (see FIG. 1) that is discharged from the HPC 24. Such a configuration enables the steam 278 to reduce hot spots in the combustor 26 from the combustion of the fuel (e.g., in particular when the fuel is supercritical hydrogen or gaseous hydrogen).

The steam 278 injected into the working gas flow path 33 also enables the HPT 28 to have a greater energy output with fewer stages of the HPT 28 as compared to HPTs without the benefit of the present disclosure. For example, the additional mass flow from the steam 278 through the turbine section 27 helps to produce a greater energy output. In this way, the HPT 28 may only have one stage capable of sustainably driving a higher number of stages of the HPC 24 (e.g., 10, 11, or 12 stages of the HPC 24) due to the higher mass flow (resulting from the steam injection) exiting the combustor 26. The steam 278 that is injected into the working gas flow path 33 enables the HPT 28 to have only one stage that drives the plurality of stages of the HPC 24 without reducing an amount of work that the HPT 28 produces as compared to HPTs without the benefit of the present disclosure, while also reducing a weight of the HPT 28 and increasing an efficiency of the HPT 28, as compared to HPTs without the benefit of the present disclosure.

With less core air 64 (see FIG. 1) needed due to the added mass flow from the steam 276, the compression ratio of the HPC 24 may be increased as compared to HPCs without the benefit of the present disclosure. In this way, the HPC 24 has a compression ratio greater than about 20:1. In some embodiments, the compression ratio of the HPC 24 is in a range of about 20:1 to about 40:1. Thus, the compression ratio of the HPC 24 is increased, thereby increasing the thermal efficiency of the turbine engine 10 as compared to HPCs and turbine engines without the benefit of the present disclosure. Further, the HPC 24 may have a reduced throat area due to the added mass flow in the turbomachine 16 provided by the steam 276, 278 injected into the turbomachine 16. Accordingly, the HPC 24 has a reduced size (e.g., outer diameter) and a reduced weight, as compared to turbine engines without the benefit of the present disclosure.

In some embodiments, the HPC stator vanes of at least two stages of the HPC 24 are variable stator vanes that are controlled to be pitched about a pitch axis to vary a pitch of the HPC stator vanes. In some embodiments, the HPC 24 includes one or more compressor bleed valves that are controlled to be opened to bleed a portion of the compressed air 65 (see FIG. 1) from the HPC 24. The one or more compressor bleed valves are preferably positioned between a fourth stage of the HPC 24 and a last stage of the HPC 24. The HPC stator vanes that are variable stator vanes, and the one or more compressor bleed valves help to balance the air flow (e.g., the compressed air 65) through the stages of the HPC 24. Such a balance, in combination with the steam 278 injected into the working gas flow path 33, enables the number of stages of the HPC 24 to include ten to twelve stages for compression ratios to be greater than about 20:1, and preferably in a range of about 20:1 to about 40:1.

The additional work that is extracted by the steam system 100 and the steam 278 injected into the working gas flow path 33 enables a size of the turbomachine 16 (FIG. 1) to be reduced, thereby increasing the bypass ratio of the turbine engine 10, as compared to turbine engines without the benefit of the present disclosure. In this way, the turbine engine 10 has a bypass ratio greater than about 18:1, preferably, in a range of about 18:1 to about 100:1, more preferably, in a range of about 25:1 to about 85:1, and, most preferably, in a range of about 28:1 to about 70:1. In this way, the steam system 100 can enable an increased bypass ratio in which the turbine engine 10 can move a larger mass of air through the bypass, reducing the pressure ratio of the fan 38 and increasing the efficiency of the turbine engine 10 as compared to turbine engines without the benefit of the present disclosure.

The turbine engine 10 may also include an engine controller 220. The engine controller 220 is configured to operate various aspects of the turbine engine 10, including, in this embodiment, the water pump 208, a fuel bypass valve 214, a selector valve 228, a first heater 232, a second heater 234, and a third heater 236. The engine controller 220 may be a Full Authority Digital Engine Control (FADEC). In this embodiment, the engine controller 220 is a computing device having one or more processors 222 and one or more memories 224. The processor 222 can be any suitable processing device, including, but not limited to, a microprocessor, a microcontroller, an integrated circuit, a logic device, a programmable logic controller (PLC), an application-specific integrated circuit (ASIC), and/or a Field Programmable Gate Array (FPGA). The memory 224 can include one or more computer-readable media, including, but not limited to, non-transitory computer-readable media, a computer-readable non-volatile medium (e.g., a flash memory), a RAM, a ROM, hard drives, flash drives, and/or other memory devices.

The memory 224 can store information accessible by the processor 222, including computer-readable instructions that can be executed by the processor 222. The instructions can be any set of instructions or a sequence of instructions that, when executed by the processor 222, causes the processor 222 and the engine controller 220 to perform operations. In some embodiments, the instructions can be executed by the processor 222 to cause the processor 222 to complete any of the operations and functions for which the engine controller 220 is configured, as will be described further below. The instructions can be software written in any suitable programming language, or can be implemented in hardware. Additionally, and/or alternatively, the instructions can be executed in logically and/or virtually separate threads on the processor 222. The memory 224 can further store data that can be accessed by the processor 222.

The technology discussed herein makes reference to computer-based systems and actions taken by, and information sent to and from, computer-based systems. One of ordinary skill in the art will recognize that the inherent flexibility of computer-based systems allows for a great variety of possible configurations, combinations, and divisions of tasks and functionality between components and among components. For instance, processes discussed herein can be implemented using a single computing device or multiple computing devices working in combination. Databases, memory, instructions, and applications can be implemented on a single system or distributed across multiple systems. Distributed components can operate sequentially or in parallel.

The fuel 67 (FIG. 1) may be heated prior to injecting the fuel 67 into the combustor 26 for various reasons. Some fuels, such as hydrocarbon-based fuels may be heated, for example, to prevent ice formation or for performance benefits. Other fuels, such as cryogenic fuels, may be heated and vaporized (converted from a liquid state in which the cryogenic fuel is stored to a vapor state for combustion), prior to being injected into the combustor 26. As noted above, the embodiments discussed herein utilize a thermal transport system to transfer heat from the turbine engine 10 and to use that heat to help heat the fuel 67. More specifically, in the embodiments discussed herein, the water 274 is used as the heat transfer fluid to transfer heat from the steam system 100 to the fuel 67 in the fuel system 80. The following discussion makes reference to cryogenic fuel and, more specifically, hydrogen fuel, but the thermal transport systems discussed herein may be applicable to other fuel systems.

The fuel tank 82 is configured to hold the hydrogen fuel at least partially within the liquid phase and is configured to provide hydrogen fuel to the fuel delivery assembly 84 substantially completely in the liquid phase, such as completely in the liquid phase. The fuel tank 82 has a fixed volume and contains a volume of the hydrogen fuel in the liquid phase (e.g., liquid hydrogen fuel). As the fuel tank 82 provides hydrogen fuel to the fuel delivery assembly 84 substantially completely in the liquid phase, the volume of the liquid hydrogen fuel in the fuel tank 82 decreases and the remaining volume in the fuel tank 82 is made up by, for example, hydrogen substantially completely in the gaseous phase (gaseous hydrogen). As used herein, the term “substantially completely” is used to describe a phase of the hydrogen fuel refers to at least 99% by mass of the described portion of the hydrogen fuel being in the stated phase, such as at least 97.5%, such as at least 95%, such as at least 92.5%, such as at least 90%, such as at least 85%, or such as at least 75% by mass of the described portion of the hydrogen fuel being in the stated phase.

To store the hydrogen fuel substantially completely in the liquid phase, the hydrogen fuel is stored in the fuel tank 82 at very low (cryogenic) temperatures, and, thus, the fuel tank 82 may also be referred to herein as a cryogenic fuel tank. For example, the hydrogen fuel may be stored in the fuel tank 82 at about −253 degrees Celsius (twenty Kelvin) or less at atmospheric pressure, or at other temperatures and pressures to maintain the hydrogen fuel substantially completely in the liquid phase. In some embodiments, the hydrogen fuel may be stored in the fuel tank 82 at temperatures from about −259 degrees Celsius (about fourteen Kelvin) to about −243 0 degrees Celsius (about thirty Kelvin), and, more preferably, from about −253 degrees Celsius (about twenty Kelvin) to about −243 degrees Celsius (about thirty Kelvin). To store the hydrogen fuel in the liquid phase, the fuel tank 82 stores and maintains the hydrogen cryogenically and may be a cryostat. The fuel tank 82 may thus be, for example, a dual wall tank, including an inner vessel (e.g., an inner cryogenic liquid tank) and an outer vessel (e.g., a vacuum vessel). The inner vessel may be positioned within the outer vessel with a gap formed between the inner vessel and the outer vessel. To provide thermal isolation for the inner vessel, the gap may be under vacuum. The gap may include a void space or be an entirely void space, but, alternatively, the gap may include multi-layer insulation (MLI), such as aluminized polyester films (e.g., aluminized Mylar®), for example.

The turbine engine 10 shown in FIG. 2 includes the thermal transport system 200 that may be used to transfer heat from the steam system 100 to the fuel system 80. The thermal transport system 200 includes a fuel heat exchanger 211 fluidly connected to the fuel delivery assembly 84. The fuel heat exchanger 211 of this embodiment is a fuel/water heat exchanger, and as the fuel 67 flows from the fuel tank 82 to the combustor 26, the fuel 67 absorbs (receives) heat from the water 274 of the steam system 100 and is heated. In some example embodiments, the fuel heat exchanger 211 may be one of the vaporizers 88 discussed above. Additionally, the fuel heat exchanger 211 may be in addition to the vaporizers 88. The fuel heat exchanger 211 may be any suitable heat exchanger, including, for example, a plate heat exchanger or a tubular heat exchanger, such as a tube and shell heat exchanger. The fuel heat exchanger 211 thus includes a fluid flow path for the heat transfer fluid.

There may be instances when heating the fuel 67 with the water 274 is not desirable or when removing heat from the water 274 is not desirable. Such conditions include startup, as discussed further below, when the water 274 is not sufficiently hot enough to flow through the fuel heat exchanger 211 and to heat the fuel 67. Accordingly, the fuel system 80 of this embodiment includes a fuel bypass line 215 (e.g., a fuel bypass flow path) that fluidly connects a portion of the fuel delivery assembly 84 upstream of the fuel heat exchanger 211 with a portion of the fuel delivery assembly 84 downstream of the fuel heat exchanger 211, thus, bypassing the fuel heat exchanger 211. The fuel system 80 is, thus, selectively operable to redirect the fuel 67, or a portion thereof, and to bypass the fuel heat exchanger 211. The fuel bypass line 215 includes a fuel bypass valve 214 located in the fuel bypass line 215 and the fuel delivery assembly 84. The fuel bypass valve 214 is operable to open and to direct the fuel 67 through the fuel bypass line 215, bypassing the fuel heat exchanger 211, and, thus, the fuel bypass valve 214 selectively operates the fuel system 80 to bypass the fuel heat exchanger 211. The fuel bypass valve 214 may be any suitable valve including a three-way valve. The fuel bypass valve 214 may also be a flow control valve (e.g., a proportional control valve) that directs a portion of the fuel 67 and or controls the flow of the fuel 67 through the fuel heat exchanger 211 and the fuel bypass line 215. The fuel bypass valve 214 may be any suitable valve including, for example, an electrically operable valve, a hydraulically operable valve, or a pneumatically operable valve. When the fuel bypass valve 214 is hydraulically operable, the hydraulic fluid may be suitable fluids of the turbine engine 10 including, for example, the fuel 67, lubrication oil, and the like.

The thermal transport system 200 includes a heat transfer loop 225 that thermally couples the condenser 204 with the fuel heat exchanger 211 to transfer heat from the condenser 204 with the fuel heat exchanger 211. More specifically, the water 274 flows through the heat transfer loop 225 to transfer heat from the condenser 204 to the fuel heat exchanger 211. The heat transfer loop 225 includes a supply line 230. The supply line 230 is fluidly connected to the line conveying the water 274 between the water pump 208 and the boiler 202. Thus, the supply line 230 is fluidly connected downstream of the water pump 208 and upstream of the boiler 202. As noted above, the water pump 208 directs the separated liquid water 274 through the boiler 202, and, with the location of the water pump 208 relative to the supply line 230, the water pump 208 may also be used to direct the flow of the water 274 through the thermal transport system 200. The water 274 thus flows from the water pump 208 through the supply line 230 to the fuel heat exchanger 211.

Although the exhaust-water mixture 270 has been cooled to a temperature low enough to condense water from the combustion gases 66, the temperature of the water 274 may still be relatively high, such as from about one hundred degrees Fahrenheit (100° F.) (about thirty-eight degrees Celsius (38° C.)) to about two hundred twelve degrees Fahrenheit (212° F.) (about one hundred degrees Celsius (100° C.)) or from about one hundred fifty degrees Fahrenheit (150° F.) (about sixty-six degrees Celsius (66° C.)) to about two hundred twelve degrees Fahrenheit (212° F.) (about one hundred degrees Celsius (100° C.)). Such temperatures are still higher than the temperature of the fuel 67, particularly, when the fuel is a cryogenic liquid fuel, such as hydrogen fuel, stored in the fuel tank 82 at cryogenic temperatures. Thus, as the water 274 flows through the fuel heat exchanger 211, the heat from the water 274 is transferred from the water 274 to the fuel 67, and the fuel 67 absorbs the heat from the water 274. The fuel 67 is thus heated and may be vaporized by the heat from the water 274 and the water 274 is cooled.

The water 274 flows from the fuel heat exchanger 211 back to the boiler 202 where the water 274 can be heated to form the steam 276 in the manner discussed above. The thermal transport system 200 thus includes a return line 226 through which the water 274 flows from the fuel heat exchanger 211 and into the boiler 202. In FIG. 2, the return line 226 is shown as being fluidly connected to the boiler 202, but, alternatively, the return line 226 may be fluidly connected to a water line upstream of the boiler 202, such as a waterline directly connecting the water pump 208 with the boiler 202.

The water 274, having been cooled by the fuel 67, may be preheated before flowing into the boiler 202. A preheat heat exchanger may be located in the return line 226 to preheat the water 274. In this embodiment, the preheat heat exchanger is the condenser 204. The thermal transport system 200 includes an intermediate return line 226 fluidly connecting the fuel heat exchanger 211 to a flow passage within the condenser 204, and the return line 226 fluidly connects the flow passage of the condenser 204 to the boiler 202. The water 274 may thus be preheated by the combustion gases 66 flowing through the condenser 204 before being introduced into the boiler 202.

The heat transfer loop 225 may be selectively operable such that the heat transfer loop 225 may be isolated or such that only a portion of the water 274 flows through the heat transfer loop 225. The heat transfer loop 225 includes a selector valve 228 located in the water line between the water pump 208 and the boiler 202. The selector valve 228 is operable to open and to direct the water 274 through the supply line 230 and to the fuel heat exchanger 211. The selector valve 228 may be any suitable valve including a three-way valve. The selector valve 228 may also be a flow control valve (e.g., a proportional control valve) that directs a portion of the water 274 and or controls the flow of the water 274 through the heat transfer loop 225. As with the fuel bypass valve 214 discussed above, the selector valve 228 may be an electrically operable valve, a hydraulically operable valve, or a pneumatically operable valve.

The water 274 is used as the heat transfer medium of the heat transfer loop 225 of this embodiment. To avoid freezing the water 274, the thermal transport system 200 includes a plurality of heaters, including a first heater 232, a second heater 234, and a third heater 236. Any suitable heater may be used including, for example, one or more electrical resistance heaters, a catalytic heater, or a burner. In some environments, startup of the turbine engine 10 may occur at cold temperatures (e.g., as low as negative forty degrees Fahrenheit (−40° F.) (negative forty degrees Celsius (−40° C.))). At startup, the turbine engine 10 and, more specifically, the combustor 26, has not begun to operate and, thus, the components in the hot gas path 78 (FIG. 1) are closer to ambient conditions than their operational temperatures. With the components of the steam system 100 and/or the thermal transport system 200 at these cold temperatures, the water 274 within the steam system 100 and the thermal transport system 200 may freeze when the water 274 comes into contact with these components. To avoid such freezing, the heaters 232, 234, 236 are used to increase the temperature of these components above the freezing point of water (thirty-two degrees Fahrenheit (32° F.) (zero degrees Celsius (0° C.))), such as from thirty-five degrees Fahrenheit (35° F.) (one degree Celsius (1° C.)) to fifty degrees Fahrenheit (50° F.) (ten degrees Celsius (10° C.)). The first heater 232 may be located in the fuel heat exchanger 211 and used to raise the temperature of the fuel heat exchanger 211. The second heater 234 may be located in the water separator 206 and used to raise the temperature of the water separator 206. The third heater 236 may be located in the condenser 204 and used to raise the temperature of the condenser 204.

One or more temperature sensors (e.g., a first temperature sensor 240, a second temperature sensor 242, a third temperature sensor 244, and a fourth temperature sensor 246) may be used with the heaters 232, 234, 236 to provide input to operate the heaters 232, 234, 236 to heat the components as discussed above. The second temperature sensor 242 may be located within the fuel heat exchanger 211 and used to detect the temperature of the fuel heat exchanger 211. The second temperature sensor 242 may be communicatively coupled to the first heater 232 and, thus, provides input to operate the first heater 232 based on the temperatures sensed by the second temperature sensor 242. Similarly, the fourth temperature sensor 246 is located within the condenser 204 and may be used to detect the temperature of the condenser 204. The third heater 236 may be operated to increase the temperature of the condenser 204 based on the temperature sensed by the fourth temperature sensor 246. The first heater 232 and the third heater 236 may thus be operated to increase the temperature of the fuel heat exchanger 211 and the third heater 236, respectively, to increase the temperatures of these components, as discussed above.

When the temperatures of the fuel heat exchanger 211 and the condenser 204 have increased sufficiently, the water 274 may be circulated through the water line connecting the water separator 206 to the boiler 202 and the heat transfer loop 225. The water 274 may be initially heated within the water separator 206 by the second heater 234. The first temperature sensor 240 may be located in the supply line 230 to determine the temperature of the supply line 230 and the water 274 flowing therein. Similarly, the third temperature sensor 244 may be located in a water line positioned downstream of the water separator 206 and upstream of the boiler 202 to determine the temperature of the water line and the water 274 flowing therein. The second heater 234 positioned in the water separator 206 may be used to increase the temperature of the water separator 206 and also the water 274 before flowing through the steam system 100 and the thermal transport system 200. The first temperature sensor 240 and the third temperature sensor 244 may thus be used to monitor the temperature of the water 274 and to provide input to operate the heaters 232, 234, 236 based on these temperatures.

When the fuel 67 is a cryogenic fuel, the fuel 67 may be directed through the fuel bypass line 215 during startup operations to avoid cooling the fuel heat exchanger 211 and negating the effects of the first heater 232. As the water 274 increases in temperature, as detected by, for example, the first temperature sensor 240, the fuel bypass valve 214 may be operated to slowly introduce the fuel 67 into the fuel heat exchanger 211.

A method of starting-up the turbine engine 10 may start with the steam injection system off due to the potential for sub-freezing temperatures. The fuel bypass valve 214 may be positioned to bypass the fuel heat exchanger 211 and have fuel 67 flow through the fuel bypass line 215. The selector valve 228 is also positioned to direct the water 274 to the boiler 202 and to bypass the heat transfer loop 225. The turbine engine 10 is started with the water pump 208 off. The turbine engine 10 is brought up to idle using, for example, a starter motor. Using the second temperature sensor 242, the temperature of the fuel heat exchanger 211 is measured. If the temperature of the fuel heat exchanger 211 is not above a heater threshold temperature, the first heater 232 is used to heat the fuel heat exchanger 211 to the temperatures discussed above. Preferably, the heater threshold temperature is greater than the freezing temperature of water (e.g., greater than thirty-two degrees Fahrenheit (32° F.) (zero degrees Celsius (0° C.))), such as from thirty-five degrees Fahrenheit (35° F.) (one degree Celsius (1° C.)) to fifty degrees Fahrenheit (50° F.) (ten degrees Celsius (10° C.)). If (or once) the temperature of the fuel heat exchanger 211 reaches the heater threshold temperature, the water pump 208 and/or the selector valve 228 is modulated (controlled) to send at least some of the water 274 through the heat transfer loop 225.

Once the water 274, flowing through the fuel heat exchanger 211, is above a minimum threshold as measured by the first temperature sensor 240, the fuel bypass valve 214 is used to modulate (e.g., control) the flow of fuel 67 into the fuel heat exchanger 211. The fuel 67 may be modulated using the fuel bypass valve 214 to maintain the water 274 above the minimum threshold temperature. The water 274 is preferably at least about eighty degrees Fahrenheit (80° F.) (about twenty-six degrees Celsius (26° C.)) before the fuel 67 is introduced into the fuel heat exchanger to prevent instant freezing of the water 274, and thus the minimum threshold may be, for example, about eighty degrees Fahrenheit (80° F.) (about twenty-six degrees Celsius (26° C.)) or more, such as, for example, from about eighty degrees Fahrenheit (80° F.) (about twenty-six degrees Celsius (26° C.)) to about one hundred sixty degrees Fahrenheit (160° F.) (about seventy-one degrees Celsius (71° C.)). A temperature at the inlet to the fuel heat exchanger 211 of about one hundred sixty degrees Fahrenheit (160° F.) (about seventy-one degrees Celsius (71° C.)) or less minimizes the potential foil boiling at altitude. As the temperature of the water 274 increases due to operation of the turbine engine 10, the selector valve 228 and/or the water pump 208 may be controlled to increase the flow of the water 274 through the thermal transport system 200 to a maximum position. The fuel bypass valve 214 may be used to modulate the fuel 67 flowing into the fuel heat exchanger 211 as the flow of water 274 flowing through the heat transfer loop 225 is increased. The flow of the water 274 and the flow of the fuel 67 are increased until the turbine engine 10 reaches a full idle operation.

Once the combustor 26 is producing the combustion gases 66, the condenser 204 and the water separator 206 have the hot combustion gases 66 flowing therethrough, providing heat to these components. During the start-up sequence, particularly for start-up when the turbine engine 10 has been exposed to sub-freezing temperatures while shutdown, the second heater 234 and the third heater 236 may be used to heat the water separator 206 and the condenser 204, respectively, to temperatures above the freezing point of water (about thirty-two degrees Fahrenheit (32° F.)), such as from about thirty-five degrees Fahrenheit (35° F.) (about one degree Celsius (1° C.)) to about fifty degrees Fahrenheit (50° F.) (about ten degrees Celsius (10° C.)). The method of starting-up the turbine engine 10 thus may also include using the fourth temperature sensor 246 to measure the temperature of the condenser 204. If the temperature of the condenser 204 is not above a heater threshold temperature (discussed above), the fourth temperature sensor 246 is used to heat the condenser 204 to the temperatures discussed above. If (or once) the temperature of the condenser 204 reaches the heater threshold temperature, the turbine engine 10 can be started, such as by igniting the fuel 67 in the combustor 26. Once the combustor ignition has occurred, the second heater 234 and the third heater 236 may be turned off. In some embodiments, the third temperature sensor 244, positioned in the water line fluidly connecting the water separator 206 with the water pump 208, can be used to control the second heater 234 during the startup sequence and determine when to turn off the second heater 234.

A method of shutting down the turbine engine 10 may include decelerating the turbine engine 10 to ground idle thrust. The fuel bypass valve 214 is positioned to bypass the fuel 67 around the fuel heat exchanger 211 and through the fuel bypass line 215. The selector valve 228 is positioned to direct the water 274 directly to the boiler 202, bypassing the heat transfer loop 225. The water pump 208 is shut off. The combustion gases 66 continue to flow through the hot gas path 78 with the water pump 208 shut off allowing the condenser 204 and the water separator 206 to be dried out at temperatures above freezing. Once dry, the pump 86 that pumps the fuel 67 from the fuel tank 82, through the fuel delivery assembly 84, can be shut off to shut down the turbine engine 10.

As noted above, the engine controller 220 is configured to operate various aspects of the turbine engine 10, including, in this embodiment, the components described in the methods above. Accordingly, in some embodiments, the engine controller 220 is configured to execute the steps of the method discussed above. More specifically, for example, the processor 222 may execute a sequence of instructions stored on the memory 224 to operate the turbine engine 10 in the manner described above.

FIG. 3 is a schematic diagram of a vapor generation system of the turbine engine 10 of FIGS. 1-2 according to an exemplary embodiment of the present disclosure.

In at least one example embodiment, the steam system 100 of the turbine engine 10 includes a vapor generation apparatus or system, such as a heat exchanger assembly 300. For example, the heat exchanger assembly 300 may be incorporated into the steam system 100 as the boiler 202, described above with respect to FIG. 2. The heat exchanger assembly 300 may include a first fluid channel 305, a plurality of first fluid passageways 310, and a plurality of second fluid passageways 315. Each of the first fluid channel 305, the plurality of first fluid passageways 310, and the plurality of second fluid passageways 315 extend between a first end 301 and a second end 302 opposite the first end 301 of the heat exchanger assembly 300. Additionally, each of the first fluid channel 305, the plurality of first fluid passageways 310, and the plurality of second fluid passageways 315 may include a plurality of tubes or conduits extending between the first end 301 and the second end 302.

In at least one example embodiment, the first fluid channel 305, the plurality of first fluid passageways 310, and the plurality of second fluid passageways 315 are arranged in a stacked relationship. For example, the plurality of first fluid passageways 310 may be between the first fluid channel 305 and the plurality of second fluid passageways 315. Moreover, the first fluid channel 305 may be adjacent a first side 321 of the heat exchanger assembly 300 and the plurality of second fluid passageways 315 may be adjacent a second side 322 opposite the first side 321 of the heat exchanger assembly 300.

In at least one example embodiment, the heat exchanger assembly 300 includes a fluid chamber 320 configured to store a first fluid. The first fluid may be a liquid, such as water. The fluid chamber 320 may be adjacent the second end 302 of the heat exchanger assembly 300 and in fluid communication with the first fluid channel 305 and the plurality of first fluid passageways 310, as will be described in greater detail below. Moreover, the heat exchanger assembly 300 may include an inlet nozzle 323 in fluid communication with the fluid chamber 320. The inlet nozzle 323 may function as an ejector by creating a low static pressure region near the inlet nozzle 323 in order to draw liquid from the first fluid channel 305 to the fluid chamber 320. Additionally, the inlet nozzle 323 may be configured to deliver the first fluid, such the water 274, to the fluid chamber 320 of the heat exchanger assembly 300, as discussed above with respect to FIG. 2.

In at least one example embodiment, the plurality of first fluid passageways 310 receive the first fluid from the fluid chamber 320. The plurality of first fluid passageways 310 are configured to heat the first fluid as it travels through the plurality of first fluid passageways 310 from the second end 302 towards the first end 301. For example, the heat exchanger assembly 300 may be in fluid communication with the working gas flow path 33 and configured to receive the combustion gases 66. The combustion gases 66 flow through the heat exchanger assembly 300 and transfer heat to the first fluid, such as the water 274, flowing through the plurality of first fluid passageways 310 to generate a second fluid, such as the steam 276, as discussed above with respect to FIG. 2. Moreover, the plurality of first fluid passageways 310 are configured to heat the first fluid (the water 274) to generate a gas-vapor mixture. For example, the gas-vapor mixture includes the water 274 and the steam 276. In at least one example embodiment, the gas-vapor mixture may be greater than or equal to about 90% vapor, such as the steam 276, by mass.

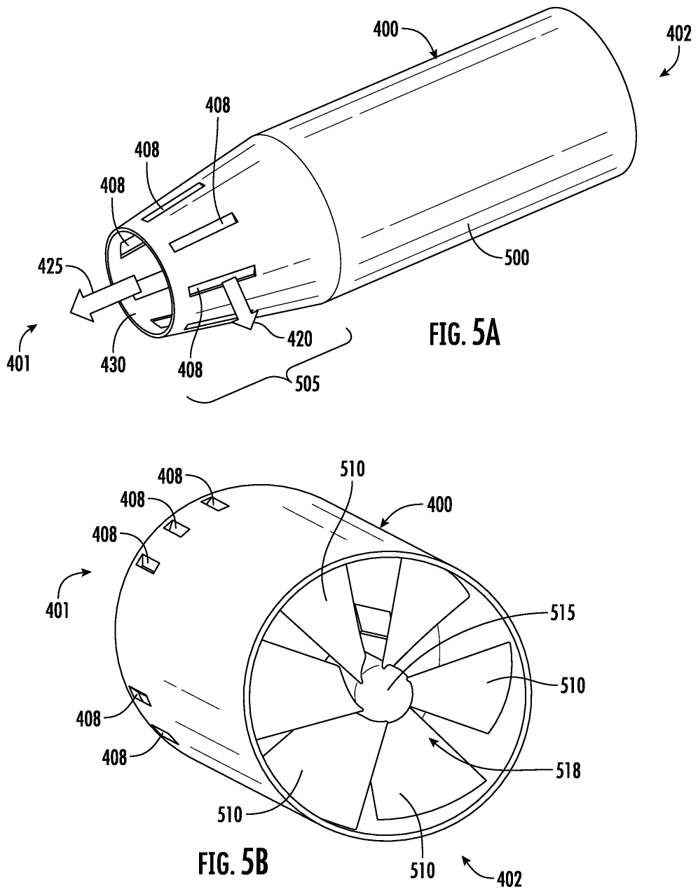

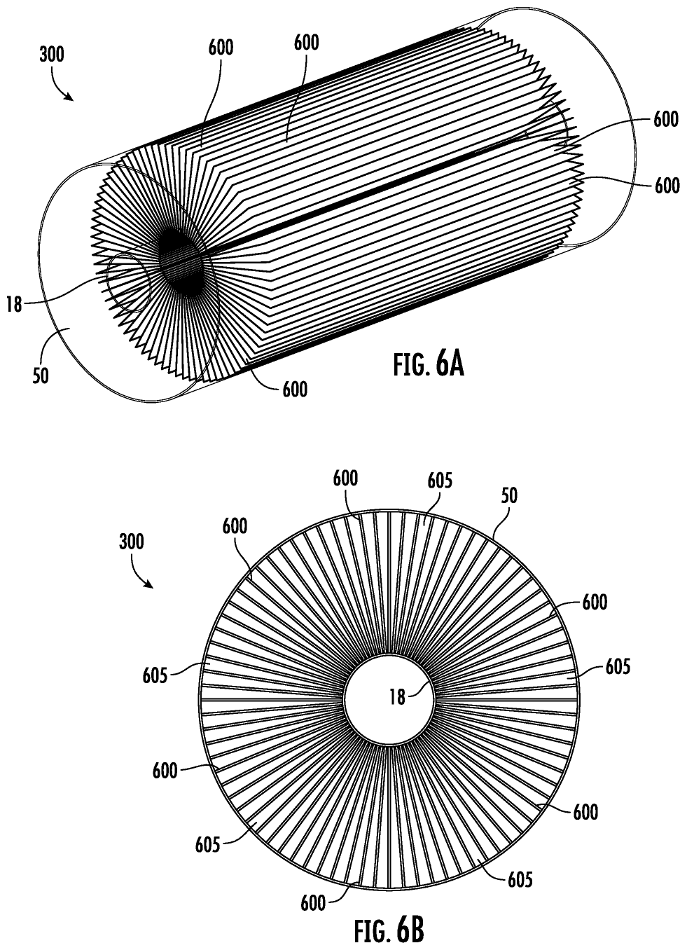

In at least one example embodiment, the heat exchanger assembly 300 includes a separator 325 adjacent the first end 301. The separator 325 may be in fluid communication with the first fluid channel 305, the plurality of first fluid passageways 310, and the plurality of second fluid passageways 315. The separator 325 is configured to separate the second fluid from the first fluid. For example, the separator 325 may include an inertial separator, as will be discussed in greater detail with respect to FIGS. 5A-5B below. The second fluid may include vapor or steam, such as the steam 276.

The second fluid and any remaining amount of the first fluid enter the separator 325 from the plurality of first fluid passageways 310. The remaining amount of the first fluid is delivered from the separator 325 to the first fluid channel 305. The first fluid channel 305 is configured to direct the first fluid to the fluid chamber 320, where it may be recirculated through the heat exchanger assembly 300. In at least one example embodiment, the first fluid channel 305 includes wicking material. The wicking material may be disposed at least partially along a length of the first fluid channel 305. The wicking material is configured to guide the first fluid within the first fluid channel 305 to the fluid chamber 320. In at least one example embodiment, the wicking material includes a mesh, sintered metal, or other porous materials.

The second fluid exits the separator 325 and travels to the plurality of second fluid passageways 315. The heat exchanger assembly 300 may include a second fluid inlet 330 adjacent the first end 301. The second fluid inlet 330 may be configured to receive the second fluid and deliver the second fluid to the plurality of second fluid passageways 315. The second fluid may be heated within the plurality of second fluid passageways 315. For example, the heat exchanger assembly 300 may be in fluid communication with the working gas flow path 33 and receive the combustion gases 66. The combustion gases 66 flow through the heat exchanger assembly 300 and transfer heat to the second fluid within the plurality of second fluid passageways 315. The second fluid travels through the plurality of second fluid passageways 315 to a second fluid outlet 335 adjacent the second end 302. The second fluid, such as the steam 276, may be directed from the second fluid outlet 335 of the heat exchanger assembly 300 to the steam turbine 210, as discussed above with respect to FIG. 2.

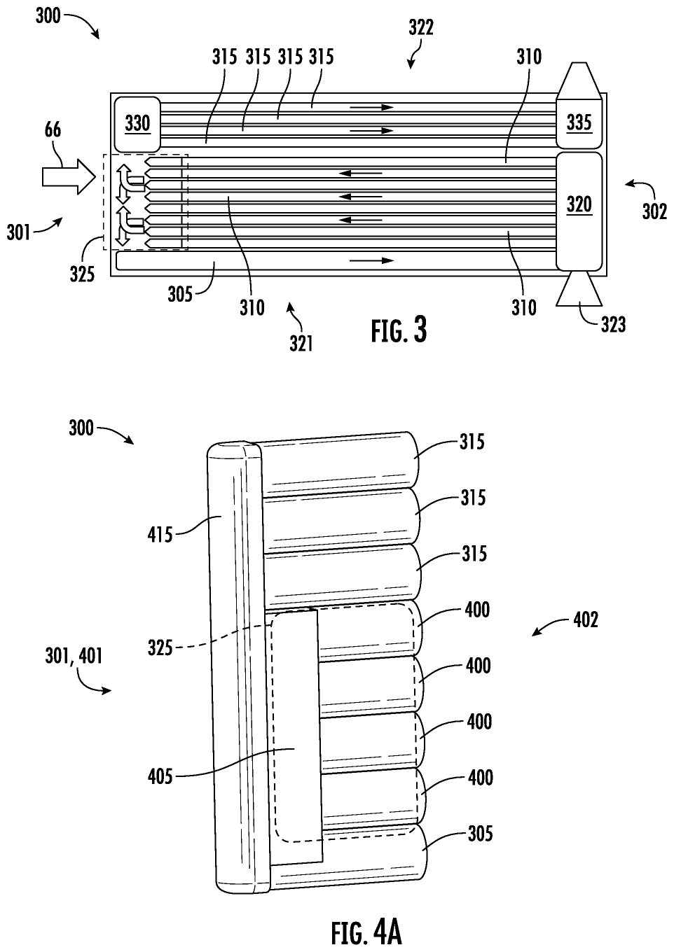

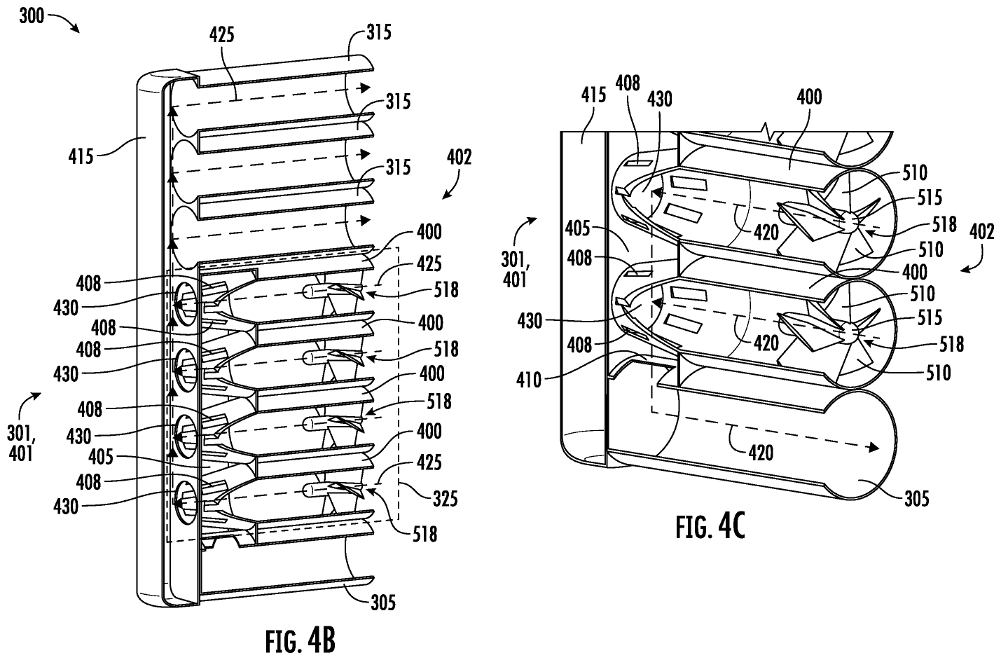

FIG. 4A is a perspective, detailed view of the separator 325 of the heat exchanger assembly 300 of FIG. 3 according to an exemplary embodiment of the present disclosure. FIG. 4B is a cross-sectional view of the separator 325 of the heat exchanger assembly 300 of FIG. 4A according to an exemplary embodiment of the present disclosure. FIG. 4C is a detailed, cross-sectional view of the separator 325 of the heat exchanger assembly 300 of FIG. 4B according to an exemplary embodiment of the present disclosure.

In at least one example embodiment, the separator 325 of the heat exchanger assembly 300 includes a plurality of separation passageways 400 extending between a first separator side 401 and a second separator side 402 opposite the first separator side 401. For example, the first separator side 401 may be adjacent the first end 301 of the heat exchanger assembly 300 and the second separator side 402 may be adjacent the plurality of first fluid passageways 310. The plurality of separation passageways 400 are in fluid communication with the plurality of first fluid passageways 310. The plurality of separation passageways 400 may include a plurality of tubes or conduits extending between the first separator side 401 and the second separator side 402. In at least one example embodiment, a number of the plurality of separation passageways 400 may be the same as a number of the plurality of first fluid passageways 310. In some additional example embodiments, the plurality of separation passageways 400 may be integral with the plurality of first fluid passageways 310.

In at least one example embodiment, the separator 325 of the heat exchanger assembly 300 includes a separation chamber 405 adjacent the first separator side 401. The separation chamber 405 is in fluid communication with the plurality of separation passageways 400. For example, as shown in FIGS. 4B-4C, each of the plurality of separation passageways 400 define a plurality of fluid openings 408 about a periphery of the plurality of separation passageways 400 adjacent the first separator side 401. The plurality of fluid openings 408 configured to fluidly couple the plurality of separation passageways 400 with the separation chamber 405. The plurality of fluid openings 408 may include a plurality of perforations or slits disposed in a periphery of each of the plurality of separation passageways 400.

With reference to FIGS. 4B-4C, the separation chamber 405 is also configured to be in fluid communication with the first fluid channel 305. For example, the first fluid is configured to exit each of the plurality of separation passageways 400 through the plurality of fluid openings 408 and flow into the first fluid channel 305 from the separation chamber 405. Moreover, a periphery of the first fluid channel 305 may define at least one inlet opening, such as a first fluid inlet 410, adjacent the first end 301 and in fluid communication with the separation chamber 405.

In at least one example embodiment, the heat exchanger assembly 300 includes a second fluid channel 415. The second fluid channel 415 may extend vertically adjacent the first end 301 of the heat exchanger assembly 300. For example, the second fluid channel 415 may be adjacent the first end 301 of the first fluid channel 305, the separator 325, and the plurality of second fluid passageways 315. The second fluid channel 415 is in fluid communication with the separator 325 and the plurality of second fluid passageways 315. More specifically, the second fluid channel 415 is in fluid communication with the plurality of separation passageways 400 and the plurality of second fluid passageways 315 to provide a fluid pathway for the second fluid to travel from the plurality of separation passageways 400 to the plurality of second fluid passageways 315. Additionally, the second fluid channel 415 is fluidly isolated from the separation chamber 405 and the first fluid channel 305. Such fluid isolation prevents the first fluid from entering the second fluid channel 415, and thereby the plurality of second fluid passageways 315.

In at least one example embodiment, the separator 325 is configured to separate the first fluid and the second fluid entering the separator 325 from the plurality of first fluid passageways 310. For example, each of the plurality of separation passageways 400 define a first fluid pathway 420 and a second fluid pathway 425. With reference to FIG. 4C, the first fluid enters the plurality of separation passageways 400 adjacent the second separator side 402 from the plurality of first fluid passageways 310. The first fluid pathway 420 of the first fluid extends from the second separator side 402 towards the first separator side 401, through the plurality of fluid openings 408, through the separation chamber 405, and into the first fluid channel 305 via the first fluid inlet 410. The first fluid may be returned to the fluid chamber 320 via the first fluid channel 305, as discussed above with respect to FIG. 3.

With reference to FIG. 4B, the second fluid enters the plurality of separation passageways 400 adjacent the second separator side 402 from the plurality of first fluid passageways 310. The plurality of separation passageways 400 are configured to separate the second fluid from the first fluid, as will be described in greater detail with respect to FIGS. 5A-5B, below. The second fluid flows along the second fluid pathway 425 from the second separator side 402 towards the first separator side 401, exits the plurality of separation passageways 400 through a second fluid outlet 430 adjacent the first separator side 401, flows into the second fluid channel 415, and enters the plurality of second fluid passageways 315. The second fluid may be delivered to the second fluid outlet 335 via the plurality of second fluid passageways 315, as described above with respect to FIG. 3.

FIG. 5A is a perspective view of one of the plurality of separation passageways 400 of the separator 325 of FIGS. 4A-4C according to an exemplary embodiment of the present disclosure. FIG. 5B is a rear, perspective view of the one of the plurality of separation passageways 400 of FIG. 5A according to an exemplary embodiment of the present disclosure.

In at least one example embodiment, each of the plurality of separation passageways 400 include a base portion 500 adjacent the second separator side 402 and a tapered surface or a tapered portion 505 adjacent the first separator side 401. For example, a diameter the base portion 500 may be constant from the second separator side 402 to the tapered portion 505 and a diameter of the tapered portion 505 decreases from the base portion 500 to the first separator side 401. The tapered portion 505 collects water vapor, such as the steam 276. A periphery of the tapered portion 505 of each of the plurality of separation passageways 400 may define the plurality of fluid openings 408. Additionally, the tapered portion 505 may define the second fluid outlet 430 adjacent the first separator side 401. The second fluid outlet 430 is in fluid communication with the plurality of separation passageways 400.

In at least one example embodiment, the separator 325 includes an inertial separator. In such embodiments, a plurality of vanes 510 are disposed in each of the plurality of separation passageways 400 adjacent the second separator side 402. For example, the plurality of vanes 510 may be disposed circumferentially about a separator hub 515. The separator hub 515 and the plurality of vanes 510 may define a swirler 518 disposed in each of the plurality of separation passageways 400 adjacent the second separator side 402. The plurality of vanes 510 are configured to add swirl to the first fluid and the second fluid entering the plurality of separation passageways 400 from the plurality of first fluid passageways 310 such that the first fluid and the second fluid are separated. The plurality of vanes 510 also facilitate smaller liquid droplets coalescing into larger liquid droplets, which may improve the liquid separation process within the separator 325.

In operation, the first fluid, such as the water 274, enters the fluid chamber 320 and flows through the plurality of first fluid passageways 310. With reference to FIG. 2, the fluid chamber 320 may receive the water 274 from a water source, such as one or both of the condenser 204 and the water separator 206. Within the plurality of first fluid passageways 310, the first fluid undergoes convective boiling that converts a portion of the first fluid (the water 274) to the second fluid (the steam 276). More specifically, only a portion of the first fluid is converted to the second fluid. For example, the boiling process is incomplete because not all the water 274 within the plurality of first fluid passageways 310 contacts the interior surface of the plurality of passageways to evaporate into vapor and form the steam 276. Accordingly, the flow entering the second separator side 402 of the separator 325 is a gas-liquid mixture.

The separator 325 separates the second fluid (the steam 276) from the first fluid (the water 274), as described above. The steam 276 flows to the plurality of second fluid passageways 315. Within the plurality of second fluid passageways 315, the steam 276 is further heated. For example, energy transferred to the plurality of second fluid passageways 315 heats the steam 276 beyond a saturation temperature (superheating) such that minimal thermal energy goes towards evaporating liquid since the steam 276 has already been separated from the water 274. With reference to FIG. 2, the steam 276 may be discharged from the plurality of second fluid passageways 315 via the second fluid outlet 335 to the steam turbine 210, then injected into working gas flow path 33, such as into the combustor 26.

FIG. 6A is a perspective view of the heat exchanger assembly 300 of FIG. 3 according to an exemplary embodiment of the present disclosure. FIG. 6B is a cross-sectional view of the heat exchanger assembly 300 of FIG. 6A according to an exemplary embodiment of the present disclosure.

In at least one example embodiment, the turbine engine 10 includes the heat exchanger assembly 300 disposed in an airflow passage. For example, the heat exchanger assembly 300 may be disposed within the bypass airflow passage 56 shown in FIGS. 1-2. In such embodiments, the heat exchanger assembly 300 may be positioned between the outer casing 18 and the nacelle 50 of the turbine engine 10. Moreover, the heat exchanger assembly 300 may be incorporated into the steam system 100 of the turbine engine 10 as the boiler 202, as described above with respect to FIG. 2.

In at least one example embodiment, the heat exchanger assembly 300 includes a plurality of plates 600. As shown in FIGS. 6A-6B, the heat exchanger assembly 300 may include an annular heat exchanger disposed in the bypass airflow passage 56. In such embodiments, the plurality of plates 600 may be disposed circumferentially within the bypass airflow passage 56. Each of the plurality of plates 600 may include the first fluid channel 305, the plurality of first fluid passageways 310, the plurality of second fluid passageways 315, and the separator 325, as discussed above with respect to FIG. 3. The first fluid channel 305 of each of the plurality of plates 600 may be adjacent the outer casing 18 and the plurality of second fluid passageways 315 of each of the plurality of plates 600 may be adjacent the nacelle 50. Accordingly, the plurality of first fluid passageways 310 of each of the plurality of plates 600 may be between the first fluid channel 305 and the plurality of second fluid passageways 315.

With reference to FIG. 6B, the heat exchanger assembly 300 defines a plurality of fluid passageways 605 between the plurality of plates 600. The plurality of fluid passageways 605 may be in fluid communication with the steam system 100. For example, the heat exchanger assembly 300 may be incorporated as the boiler 202, as shown in FIG. 2, and the plurality of fluid passageways 605 may be configured to receive the combustion gases 66. The combustion gases 66 flow through the plurality of fluid passageways 605 and transfer heat to the first fluid and the second fluid flowing through the plurality of first fluid passageways 310 and the plurality of second fluid passageways 315, as discussed above with respect to FIGS. 2-3.

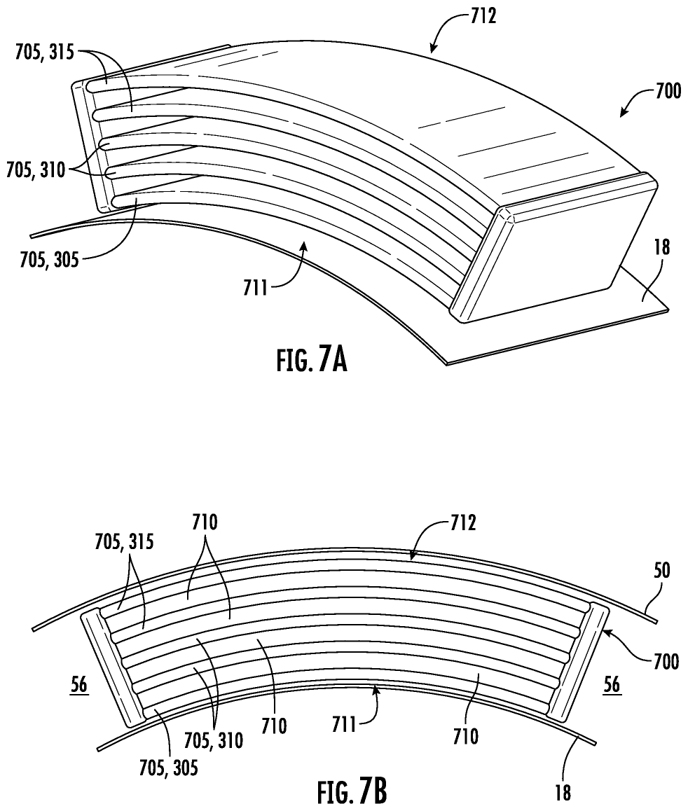

FIG. 7A is a perspective view of a vapor generation system according to an exemplary embodiment of the present disclosure. FIG. 7B is a cross-sectional view of the vapor generation system of FIG. 6A according to an exemplary embodiment of the present disclosure.

A vapor generation system, such as a heat exchanger assembly 700, may be configured in a similar manner as the exemplary heat exchanger assembly 300 discussed above with respect to FIGS. 6A-6B. For example, the heat exchanger assembly 700 may be disposed within an airflow passage of the turbine engine 10, such as the bypass airflow passage 56. In such embodiments, the heat exchanger assembly 700 may be between the outer casing 18 and the nacelle 50 of the turbine engine 10. Moreover, the heat exchanger assembly 700 may be incorporated into the steam system 100 of the turbine engine 10 as the boiler 202, as described above with respect to FIG. 2.

In at least one example embodiment, the heat exchanger assembly 700 includes a plurality of plates 705. As shown in FIGS. 7A-7B, the plurality of plates 705 may be arranged in a stacked relationship. For example, the plurality of plates 705 may be stacked between a first side 711 and a second side 712 opposite the first side 711 of the heat exchanger assembly 700. The first side 711 may be adjacent the outer casing 18 and the second side 712 may be adjacent the nacelle 50.

In at least one example embodiment, the plurality of plates 705 include the first fluid channel 305, the plurality of first fluid passageways 310, and the plurality of second fluid passageways 315. More specifically, the first fluid channel 305 may include at least one of the plurality of plates 705 positioned adjacent the first side 711, the plurality of second fluid passageways 315 may include one or more of the plurality of plates 705 adjacent the second side 712, and the plurality of first fluid passageways 310 may include one or more of the plurality of plates 705 between the plurality of plates 705 including the first fluid channel 305 and the plurality of second fluid passageways 315. Although FIGS. 7A-7B illustrate one of the plurality of plates 705 for the first fluid channel 305 and two of the plurality of plates 705 for each of the plurality of first fluid passageways 310 and the plurality of second fluid passageways 315, it should be understood that the heat exchanger assembly 700 may include any number of the plurality of plates 705 for each of the first fluid channel 305, the plurality of first fluid passageways 310, and the plurality of second fluid passageways 315.

With reference to FIG. 7B, the heat exchanger assembly 700 defines a plurality of fluid passageways 710 between the plurality of plates 705. The plurality of fluid passageways 710 may be in fluid communication with the steam system 100. For example, the heat exchanger assembly 700 may be incorporated as the boiler 202, as shown in FIG. 2, and the plurality of fluid passageways 710 may be configured to receive the combustion gases 66. The combustion gases 66 flow through the plurality of fluid passageways 710 and transfer heat to the first fluid and the second fluid flowing through the plurality of first fluid passageways 310 and the plurality of second fluid passageways 315, as discussed above with respect to FIGS. 2-3.

In at least one example embodiment, the heat exchanger assembly 700 may include a plurality of heat exchanger assemblies. In such embodiments, the plurality of the heat exchanger assemblies 700 may be disposed circumferentially within and about the bypass airflow passage 56.

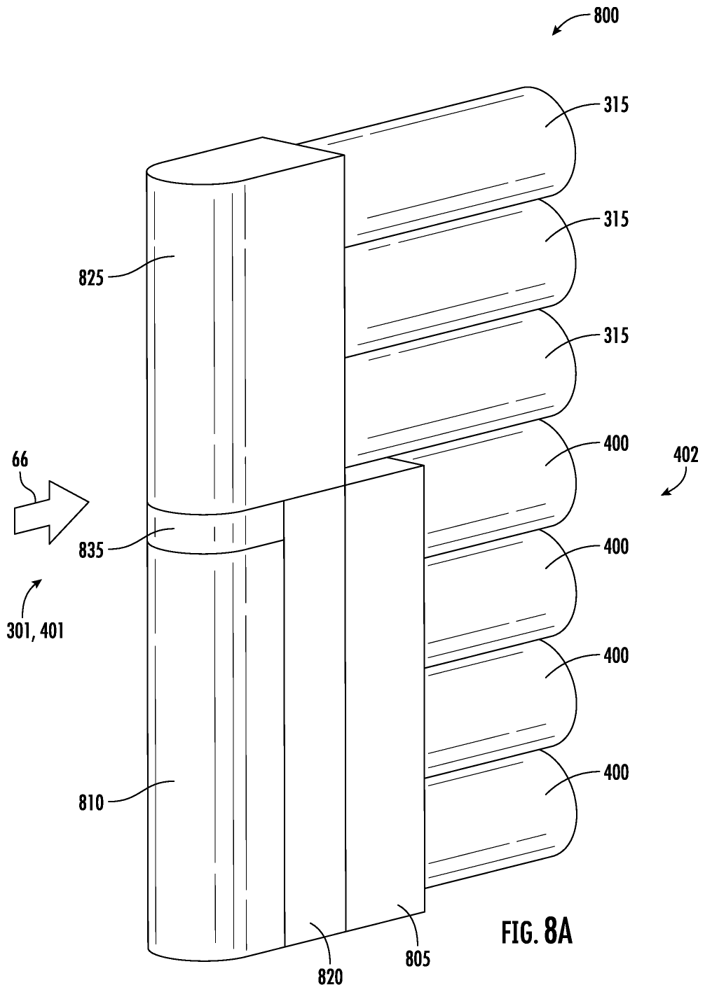

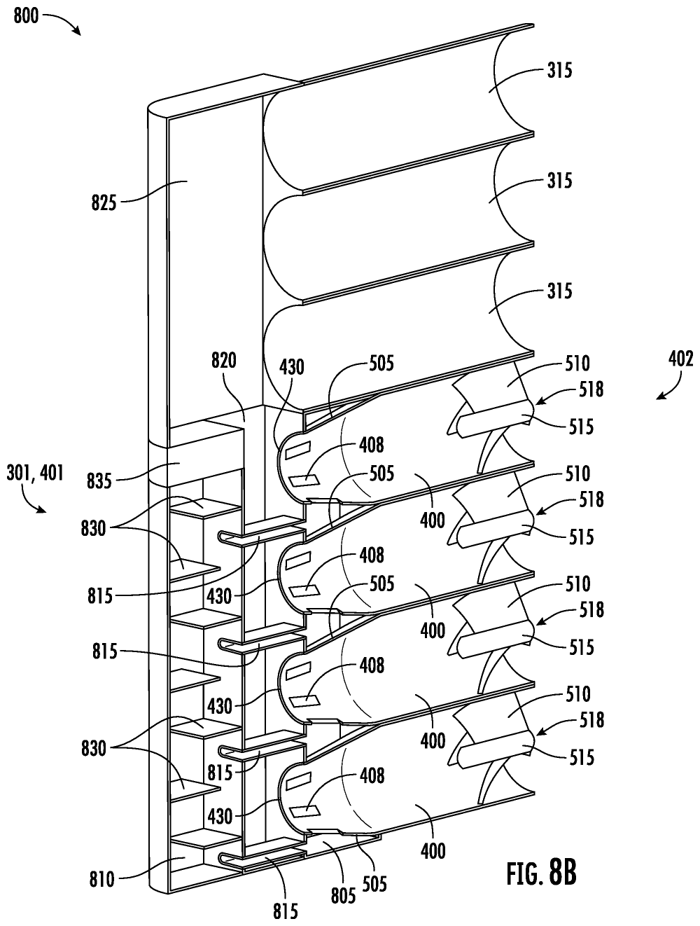

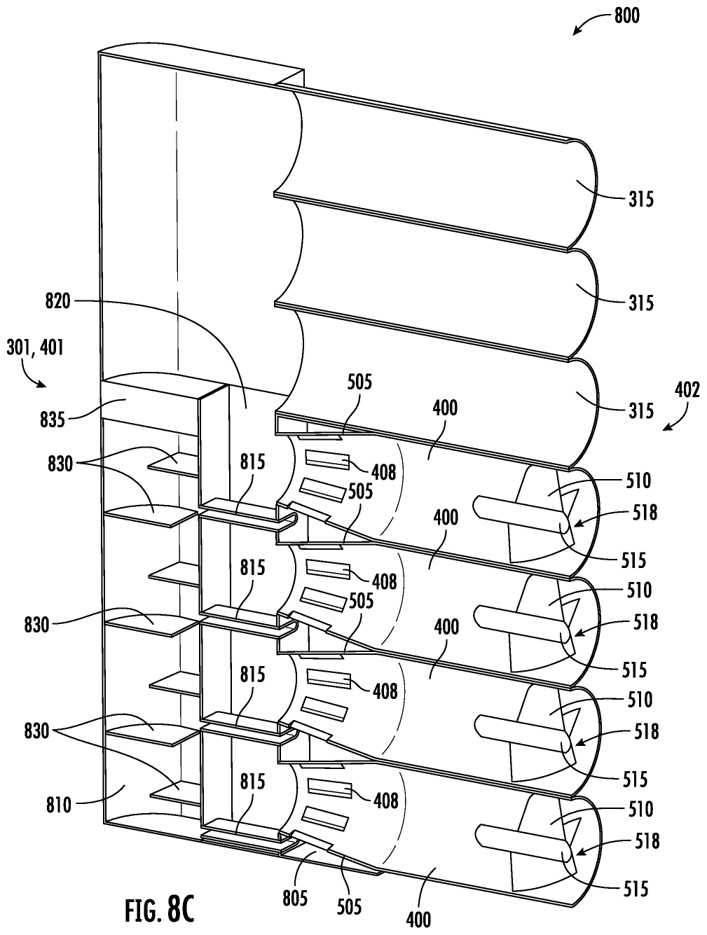

FIG. 8A is a perspective view of another vapor generation system of the turbine engine 10 of FIGS. 1-2 according to an exemplary embodiment of the present disclosure. FIG. 8B is a cross-sectional view of the vapor generation system of FIG. 8A according to an exemplary embodiment of the present disclosure. FIG. 8C is a cross-sectional view of the vapor generation system of FIG. 8A according to an exemplary embodiment of the present disclosure.

In at least one example embodiment, the vapor generation system of the steam system 100 includes a heat exchanger assembly 800. The heat exchanger assembly 800 may be configured in a similar manner as the exemplary heat exchanger assembly 300 discussed above with respect to FIGS. 3-5B. For example, the heat exchanger assembly 800 includes, at least, the plurality of separation passageways 400 and the plurality of second fluid passageways 315, which may be similar or analogous to the plurality of separation passageways 400 and the plurality of second fluid passageways 315 discussed above with respect to FIGS. 3-5B. Moreover, the heat exchanger assembly 800 may be used in place of the heat exchanger assembly 300 in some example embodiments.

In at least one example embodiment, the heat exchanger assembly 800 includes the plurality of separation passageways 400 extending between the first separator side 401 and the second separator side 402. The plurality of separation passageways 400 may be similar or analogous to the plurality of separation passageways discussed above with respect to FIGS. 4A-5B. With reference to FIGS. 8B-8C, each of the plurality of separation passageways 400 include the swirler 518 disposed adjacent the second separator side 402 and the tapered portion 505 adjacent the first separator side 401. The swirler 518 includes the plurality of vanes 510 extending circumferentially about the separator hub 515. The swirler 518 is configured to add swirl to a vapor-liquid mixture, such as the first fluid and the second fluid, received from the plurality of first fluid passageways 310 such that the first fluid and the second fluid may be at least partially separated. For example, the first fluid, such as the water 274, in the form of liquid droplets may flow radially outward towards the interior walls of the plurality of separation passageways 400. The first fluid in the form of liquid droplets or liquid film formed from the swirl may be discharged through the plurality of fluid openings 408 defined by the tapered portion 505 of the plurality of separation passageways 400 to a fluid cavity 805. For example, each of the plurality of fluid openings 408 are in fluid communication with the fluid cavity 805.

In at least one example embodiment, the fluid cavity 805 is adjacent the first separator side 401 and defined between the tapered portion 505 of each of the plurality of separation passageways 400. The fluid cavity 805 is in fluid communication with a re-boiling cavity 810 adjacent the first separator side 401. The re-boiling cavity 810 may form a leading edge of the heat exchanger assembly 800 such that the fluid cavity 805 is between the re-boiling cavity 810 and the plurality of separation passageways 400. Moreover, a plurality of fluid crossover pathways 815 may be defined between the fluid cavity 805 and the re-boiling cavity 810. The first fluid, such as the liquid droplets, may flow from the fluid cavity 805 to the re-boiling cavity 810 via the plurality of fluid crossover pathways 815. For example, the plurality of fluid crossover pathways 815 may include a wicking material for directing the first fluid from the fluid cavity 805 to the re-boiling cavity 810.

In at least one example embodiment, a number of the plurality of fluid crossover pathways 815 is the same as a number of the plurality of separation passageways 400. For example, at least one of the plurality of fluid crossover pathways 815 may be associated with each of the plurality of separation passageways 400. In other example embodiments, the plurality of fluid crossover pathways 815 may be between the tapered portion 505 of each of the plurality of separation passageways 400. For example, one of the plurality of fluid crossover pathways 815 may be between the tapered portion 505 of two adjacent ones of the plurality of separation passageways 400 such that the number of the plurality of fluid crossover pathways 815 is one less than the number of the plurality of separation passageways 400.

The second fluid is discharged from the second fluid outlet 430 of the plurality of separation passageways 400 into a vapor cavity 820. The vapor cavity 820 may be adjacent the first separator side 401. More specifically, the vapor cavity 820 may be between the fluid cavity 805 and the re-boiling cavity 810. Additionally, the plurality of fluid crossover pathways 815 may be at least partially disposed in the vapor cavity 820 and fluidly isolated from the vapor cavity 820. Moreover, the vapor cavity 820 is in fluid communication with the plurality of second fluid passageways 315 via a vapor manifold 825. The vapor manifold 825 defines a fluid channel through which the second fluid, or vapor, may flow from the vapor cavity 820 to the plurality of second fluid passageways 315.

In at least one example embodiment, the re-boiling cavity 810 is configured to heat the first fluid received from the fluid cavity 805 via the plurality of fluid crossover pathways 815. For example, the combustion gases 66 are configured to flow through the heat exchanger assembly 800 in a similar manner as the heat exchanger assembly 300, as discussed above with respect to FIG. 2. Because the re-boiling cavity 810 is adjacent the first separator side 401, such that it forms a leading edge of the heat exchanger assembly 800, the combustion gases 66 come into contact with the re-boiling cavity 810 and transfer heat to the first fluid therein. Accordingly, the first fluid is heated within the re-boiling cavity 810 and the second fluid, such as the steam 276, is generated.

With reference to FIGS. 8B-8C, the re-boiling cavity 810 defines a tortuous pathway trough which the first fluid and the second fluid flow. For example, a plurality of baffles 830 may be disposed in the re-boiling cavity 810. As shown in FIGS. 8B-8C, the plurality of baffles 830 may be disposed in an alternating arrangement defining the tortuous pathway. The tortuous pathways defined between the plurality of baffles 830 is configured to increase the liquid residence time within the re-boiling cavity 810 and enhance liquid droplet coalescence.

In at least one example embodiment, the re-boiling cavity 810 generates a liquid-vapor mixture including the first fluid and the second fluid. The liquid-vapor mixture is discharged from the re-boiling cavity to a mist eliminator 835. As shown in FIGS. 8A-8C, the mist eliminator 835 may be between the re-boiling cavity 810 and the vapor cavity 820. In at least one example embodiment, the mist eliminator 835 includes a porous pad. In some additional example embodiments, the mist eliminator 835 includes a porous structure formed of a plurality of wires.

The mist eliminator 835 is configured to collect liquid droplets. For example, the mist eliminator 835 collects and traps the first fluid from the liquid-vapor mixture to prevent the first fluid from flowing to the vapor manifold 825 while allowing the second fluid to pass through the mist eliminator 835 to the vapor manifold 825. Additionally, a wicking material may be disposed at least partially within the re-boiling cavity 810 for directing the first fluid from the mist eliminator 835 to the re-boiling cavity 810.

The second fluid discharged from the re-boiling cavity 810 and the mist eliminator 835 and is combined with the second fluid discharged from the vapor cavity 820 within the vapor manifold 825. From the vapor manifold 825, the second fluid may flow into the plurality of second fluid passageways 315 such that the second fluid is further heated to a degree of superheat, as described above. Moreover, with reference to FIG. 2, the second fluid (the steam 276) may be discharged from the plurality of second fluid passageways 315 via the second fluid outlet 335 to the steam turbine 210, then injected into working gas flow path 33, such as into the combustor 26.

Further aspects are provided by the subject matter of the following clauses:

A vapor generation apparatus, comprising: a fluid channel extending between a first end and a second end of the vapor generation apparatus; a plurality of first fluid passageways extending between the first end and the second end; a plurality of second fluid passageways extending between the first end and the second end, wherein the plurality of first fluid passageways are disposed between the fluid channel and the plurality of second fluid passageways; a fluid chamber adjacent the second end and configured to receive a first fluid, wherein the fluid chamber is in fluid communication with the fluid channel and the plurality of first fluid passageways; and a separator adjacent the first end and in fluid communication with the fluid channel, the plurality of first fluid passageways, and the plurality of second fluid passageways; wherein the fluid channel is configured to receive the first fluid from the separator; and wherein the plurality of second fluid passageways are configured to receive a second fluid from the separator.

The vapor generation apparatus of any preceding clause, wherein: the plurality of first fluid passageways are configured to heat the first fluid; and the separator is configured to separate the first fluid and the second fluid.

The vapor generation apparatus of any preceding clause, wherein: the plurality of first fluid passageways are configured to heat the first fluid to generate a gas-vapor mixture including the first fluid and the second fluid; and the gas-vapor mixture is greater than or equal to 90% vapor by mass.

The vapor generation apparatus of any preceding clause, wherein: the first fluid comprises a liquid; and the second fluid comprises a vapor.

The vapor generation apparatus of any preceding clause, wherein: the fluid channel comprises a first fluid channel; the separator is adjacent the first end and the plurality of first fluid passageways; and the separator comprises: a plurality of separation passageways extending between a first separator end and a second separator end, the first separator end adjacent the first end and the second separator end adjacent the plurality of first fluid passageways, and a separation chamber adjacent the first separator end and in fluid communication with the plurality of separation passageways.

The vapor generation apparatus of any preceding clause, wherein: the separator is in fluid communication with the fluid channel via the separation chamber; and the separator is in fluid communication with the plurality of second fluid passageways via a second fluid channel adjacent the first end.

The vapor generation apparatus of any preceding clause, further comprising a wicking material disposed in the separation chamber, the wicking material configured to guide the first fluid from the separation chamber to the fluid channel.

The vapor generation apparatus of any preceding clause, wherein: a plurality of vanes are disposed circumferentially within the separator adjacent the second separator end; and each of the plurality of separation passageways define a plurality of openings adjacent the first separator end, the plurality of openings in fluid communication with the separation chamber.

The vapor generation apparatus of any preceding clause, wherein: the separator includes at least one first fluid pathway flowing from the second separator end to the first separator end, through the plurality of openings, and to the first fluid channel; and the separator includes at least one second fluid pathway flowing from the second separator end to the first separator end and to the plurality of second fluid passageways.

The vapor generation apparatus of any preceding clause, wherein each of the plurality of separation passageways comprise a tapered surface adjacent the second separator end, the tapered surface including the plurality of openings.

The vapor generation apparatus of any preceding clause, wherein the first fluid channel defines at least one inlet opening adjacent the first end fluidly coupling the separator and the first fluid channel.

The vapor generation apparatus of any preceding clause, further comprising a wicking material disposed in the first fluid channel, the wicking material configured to guide the first fluid within the first fluid channel to the fluid chamber.

The vapor generation apparatus of any preceding clause, wherein the first fluid channel, the plurality of first fluid passageways, and the plurality of second fluid passageways are arranged in a stacked relationship.

The vapor generation apparatus of any preceding clause, further comprising an inlet nozzle fluidly coupled to the fluid chamber, the inlet nozzle configured to deliver the first fluid to the fluid chamber.

The vapor generation apparatus of any preceding clause, wherein the separator comprises: a plurality of separation passageways extending between a first separator end and a second separator end, the first separator end adjacent the first end and the second separator end adjacent the plurality of first fluid passageways; a fluid cavity in fluid communication with the plurality of separation passageways and configured to receive the first fluid; a re-boiling cavity adjacent the first separator end; a vapor cavity in fluid communication with the plurality of separation passageways and configured to receive the second fluid, the vapor cavity between the fluid cavity and the re-boiling cavity; and a plurality of fluid crossover channels disposed in the vapor cavity and configured to fluidly couple the plurality of separation passageways and the re-boiling cavity.

The vapor generation apparatus of any preceding clause, wherein: the separator includes at least one first fluid pathways flowing from the plurality of separation passageways, the fluid cavity, the plurality of fluid crossover channels, and the re-boiling cavity; and the separator includes at least one second fluid pathways flowing from the plurality of separation passageways to the vapor cavity.

The vapor generation apparatus of any preceding clause, wherein the separator further comprises a vapor manifold in fluid communication with the re-boiling cavity and the vapor cavity, the vapor manifold configured to discharge the second fluid to the plurality of second fluid passageways.

The vapor generation apparatus of any preceding clause, wherein the separator further comprises a mist eliminator in fluid communication with the re-boiling cavity and the vapor manifold, the mist eliminator configured to prevent the first fluid from flowing to the vapor manifold.

The vapor generation apparatus of any preceding clause, wherein the separator further comprises a wicking material disposed in the re-boiling cavity, the wicking material configured to guide the first fluid from the mist eliminator to the re-boiling cavity.

A turbine engine, comprising: a turbomachine comprising a compressor section, a combustion section, and a turbine section in serial flow order and together defining a working gas flow path; a steam system operable with the turbomachine; and a heat exchanger in fluid communication with the steam system, wherein the heat exchanger comprises: a fluid channel extending between a first end and a second end of the heat exchanger, a plurality of first fluid passageways extending between the first end and the second end, a plurality of second fluid passageways extending between the first end and the second end, wherein the plurality of first fluid passageways are between the fluid channel and the plurality of second fluid passageways, a fluid chamber adjacent the second end and configured to receive a first fluid, wherein the fluid chamber is in fluid communication with the fluid channel and the plurality of first fluid passageways, and a separator adjacent the first end and in fluid communication with the fluid channel, the plurality of first fluid passageways, and the plurality of second fluid passageways.

The turbine engine of any preceding clause, wherein: the fluid channel is configured to receive the first fluid from the separator; and the plurality of second fluid passageways are configured to receive a second fluid from the separator.

The turbine engine of any preceding clause, wherein: the plurality of first fluid passageways are configured to heat the first fluid; and the separator is configured to separate the first fluid and the second fluid.

The turbine engine of any preceding clause, wherein: the plurality of first fluid passageways are configured to heat the first fluid to generate a gas-vapor mixture including the first fluid and the second fluid; and the gas-vapor mixture is greater than or equal to 90% vapor by mass.

The turbine engine of any preceding clause, wherein: the first fluid comprises a liquid; and the second fluid comprises a vapor.

The turbine engine of any preceding clause, wherein: the separator is adjacent the first end and the plurality of first fluid passageways; and the separator comprises: a plurality of separation passageways extending between a first separator end and a second separator end, the first separator end adjacent the first end and the second separator end adjacent the plurality of first fluid passageways, and a separation chamber adjacent the first separator end and in fluid communication with the plurality of separation passageways.

The turbine engine of any preceding clause, wherein: the fluid channel comprises a first fluid channel; the separator is in fluid communication with the first fluid channel via the separation chamber; and the separator is in fluid communication with the plurality of second fluid passageways via a second fluid channel adjacent the first end.

The turbine engine of any preceding clause, further comprising a wicking material disposed in the separation chamber, the wicking material configured to guide the first fluid from the separation chamber to the first fluid channel.

The turbine engine of any preceding clause, wherein: a plurality of vanes are disposed circumferentially within the separator adjacent the second separator end; and each of the plurality of separation passageways define a plurality of openings adjacent the second separator end, the plurality of openings in fluid communication with the separation chamber.

The turbine engine of any preceding clause, wherein: the separator includes at least one first fluid pathway flowing from the second separator end to the first separator end, through the plurality of openings, and to the fluid channel; and the separator includes at least one second fluid pathway flowing from the second separator end to the first separator end and to the plurality of second fluid passageways.

The turbine engine of any preceding clause, wherein each of the plurality of separation passageways comprise a tapered surface adjacent the second separator end, the tapered surface including the plurality of openings.

The turbine engine of any preceding clause, wherein the first fluid channel defines at least one inlet opening adjacent the first end fluidly coupling the separator and the first fluid channel.

The turbine engine of any preceding clause, further comprising a wicking material disposed in the first fluid channel, the wicking material configured to guide the first fluid within the first fluid channel to the fluid chamber.

The turbine engine of any preceding clause, wherein the first fluid channel, the plurality of first fluid passageways, and the plurality of second fluid passageways are arranged in a stacked relationship.

The turbine engine of any preceding clause, further comprising an inlet nozzle fluidly coupled to the fluid chamber, the inlet nozzle configured to deliver the first fluid to the fluid chamber.

The turbine engine of any preceding clause, wherein the heat exchanger comprises an annular heat exchanger disposed circumferentially within the turbine engine.

The turbine engine of any preceding clause, wherein: the plurality of second fluid passageways is adjacent a nacelle of the turbine engine; and the fluid channel is opposite the plurality of second fluid passageways.

The turbine engine of any preceding clause, wherein the heat exchanger comprises a plurality of heat exchangers disposed circumferentially within the turbine engine.

The turbine engine of any preceding clause, wherein the separator comprises: a plurality of separation passageways extending between a first separator end and a second separator end, the first separator end adjacent the first end and the second separator end adjacent the plurality of first fluid passageways; a fluid cavity in fluid communication with the plurality of separation passageways and configured to receive the first fluid; a re-boiling cavity adjacent the first separator end; a vapor cavity in fluid communication with the plurality of separation passageways and configured to receive a second fluid, the vapor cavity between the fluid cavity and the re-boiling cavity; and a plurality of fluid crossover channels disposed in the vapor cavity and configured to fluidly couple the plurality of separation passageways and the re-boiling cavity.

The turbine engine of any preceding clause, wherein: the separator includes at least one first fluid pathways flowing from the plurality of separation passageways, the fluid cavity, the plurality of fluid crossover channels, and the re-boiling cavity; and the separator includes at least one second fluid pathways flowing from the plurality of separation passageways to the vapor cavity.

The turbine engine of any preceding clause, wherein the separator further comprises a vapor manifold in fluid communication with the re-boiling cavity and the vapor cavity, the vapor manifold configured to discharge the second fluid to the plurality of second fluid passageways.

The turbine engine of any preceding clause, wherein the separator further comprises a mist eliminator in fluid communication with the re-boiling cavity and the vapor manifold, the mist eliminator configured to prevent the first fluid from flowing to the vapor manifold.

The turbine engine of any preceding clause, wherein the separator further comprises a wicking material disposed in the re-boiling cavity, the wicking material configured to guide the first fluid from the mist eliminator to the re-boiling cavity.

This written description uses examples to disclose the present disclosure, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

We claim:

1. A vapor generation apparatus, comprising:
a fluid channel extending between a first end and a second end of the vapor generation apparatus;
a plurality of first fluid passageways extending between the first end and the second end;
a plurality of second fluid passageways extending between the first end and the second end, wherein the plurality of first fluid passageways are disposed between the fluid channel and the plurality of second fluid passageways;
a fluid chamber adjacent the second end and configured to receive a first fluid, wherein the fluid chamber is in fluid communication with the fluid channel and the plurality of first fluid passageways; and
a separator adjacent the first end and in fluid communication with the fluid channel, the plurality of first fluid passageways, and the plurality of second fluid passageways;
wherein the fluid channel is configured to receive the first fluid from the separator; and
wherein the plurality of second fluid passageways are configured to receive a second fluid from the separator.

2. The vapor generation apparatus of claim 1, wherein:
the plurality of first fluid passageways are configured to heat the first fluid; and
the separator is configured to separate the first fluid and the second fluid.

3. The vapor generation apparatus of claim 2, wherein:
the plurality of first fluid passageways are configured to heat the first fluid to generate a gas-vapor mixture including the first fluid and the second fluid; and
the gas-vapor mixture is greater than or equal to 90% vapor by mass.

4. The vapor generation apparatus of claim 1, wherein:
the separator is adjacent the first end and the plurality of first fluid passageways; and
the separator comprises:
a plurality of separation passageways extending between a first separator end and a second separator end, the first separator end adjacent the first end and the second separator end adjacent the plurality of first fluid passageways, and
a separation chamber adjacent the first separator end and in fluid communication with the plurality of separation passageways.

5. The vapor generation apparatus of claim 4, wherein:
the fluid channel comprises a first fluid channel;
the separator is in fluid communication with the first fluid channel via the separation chamber; and
the separator is in fluid communication with the plurality of second fluid passageways via a second fluid channel adjacent the first end.

6. The vapor generation apparatus of claim 4, wherein:
a plurality of vanes are disposed circumferentially within the separator adjacent the second separator end; and
each of the plurality of separation passageways define a plurality of openings adjacent the first separator end, the plurality of openings in fluid communication with the separation chamber.

7. The vapor generation apparatus of claim 6, wherein:
the separator includes at least one first fluid pathway flowing from the second separator end to the first separator end, through the plurality of openings, and to the fluid channel; and
the separator includes at least one second fluid pathway flowing from the second separator end to the first separator end and to the plurality of second fluid passageways.

8. The vapor generation apparatus of claim 1, wherein the fluid channel, the plurality of first fluid passageways, and the plurality of second fluid passageways are arranged in a stacked relationship.

9. The vapor generation apparatus of claim 1, further comprising an inlet nozzle fluidly coupled to the fluid chamber, the inlet nozzle configured to deliver the first fluid to the fluid chamber.

10. A turbine engine, comprising:
a turbomachine comprising a compressor section, a combustion section, and a turbine section in serial flow order and together defining a working gas flow path;
a steam system operable with the turbomachine; and
a heat exchanger in fluid communication with the steam system, wherein the heat exchanger comprises:
a fluid channel extending between a first end and a second end of the heat exchanger,
a plurality of first fluid passageways extending between the first end and the second end,
a plurality of second fluid passageways extending between the first end and the second end, wherein the plurality of first fluid passageways are between the fluid channel and the plurality of second fluid passageways,
a fluid chamber adjacent the second end and configured to receive a first fluid, wherein the fluid chamber is in fluid communication with the fluid channel and the plurality of first fluid passageways, and
a separator adjacent the first end and in fluid communication with the fluid channel, the plurality of first fluid passageways, and the plurality of second fluid passageways.

11. The turbine engine of claim 10, wherein:
the fluid channel is configured to receive the first fluid from the separator; and
the plurality of second fluid passageways are configured to receive a second fluid from the separator.

12. The turbine engine of claim 11, wherein:
the plurality of first fluid passageways are configured to heat the first fluid; and
the separator is configured to separate the first fluid and the second fluid.

13. The turbine engine of claim 12, wherein:
the plurality of first fluid passageways are configured to heat the first fluid to generate a gas-vapor mixture including the first fluid and the second fluid; and
the gas-vapor mixture is greater than or equal to 90% vapor by mass.

14. The turbine engine of claim 10, wherein:
the separator is adjacent the first end and the plurality of first fluid passageways; and
the separator comprises:
a plurality of separation passageways extending between a first separator end and a second separator end, the first separator end adjacent the first end and the second separator end adjacent the plurality of first fluid passageways, and
a separation chamber adjacent the first separator end and in fluid communication with the plurality of separation passageways.

15. The turbine engine of claim 14, wherein:
the fluid channel comprises a first fluid channel;
the separator is in fluid communication with the first fluid channel via the separation chamber; and
the separator is in fluid communication with the plurality of second fluid passageways via a second fluid channel adjacent the first end.

16. The turbine engine of claim 14, wherein:
a plurality of vanes are disposed circumferentially within the separator adjacent the second separator end; and
each of the plurality of separation passageways define a plurality of openings adjacent the second separator end, the plurality of openings in fluid communication with the separation chamber.

17. The turbine engine of claim 16, wherein:
the separator includes at least one first fluid pathway flowing from the second separator end to the first separator end, through the plurality of openings, and to the fluid channel; and
the separator includes at least one second fluid pathway flowing from the second separator end to the first separator end and to the plurality of second fluid passageways.

18. The turbine engine of claim 10, wherein the heat exchanger comprises an annular heat exchanger disposed circumferentially within the turbine engine.

19. The turbine engine of claim 18, wherein:
the plurality of second fluid passageways is adjacent a nacelle of the turbine engine; and
the fluid channel is opposite the plurality of second fluid passageways.

20. The turbine engine of claim 10, wherein the heat exchanger comprises a plurality of heat exchangers disposed circumferentially within the turbine engine.
